(19) United States
(12) Patent Application Publication
(10) Pub. No.: US 2010/0233663 A1
(43) Pub. Date: Sep. 16, 2010

(54) SKILLS COMPETENCY TOOL

(75) Inventors: JUDITH ANNE PENNINGTON, Mendota Heights, MN (US); Peter Frederick Talmers, Chicago, IL (US); Oneka Esteen Jefferson-Cornelius, Fayetteville, GA (US); Judith Alicia Embree, Delaware, OH (US)

Correspondence Address: ACCENTURE CHICAGO 28164;BRINKS HOFER GILSON & LIONE, P O BOX 10395, CHICAGO, IL, 60610, US

(73) Assignee: Accenture Global Services GmbH, Schaffhausen (CH)

(21) Appl. No.: 12/719,635

(22) Filed: Mar. 8, 2010

Related U.S. Application Data
(60) Provisional application No. 61/158,741, filed on Mar. 10, 2009.

(51) Int. Cl. G09B 19/00

(52) U.S. Cl. 434/219

(57) ABSTRACT

A skills competency tool provides a quick and efficient way to assess an organization's workforce capability maturity, and generate a workforce transformation roadmap. The skills competency tool provides a way to assess and recommend modifications to job and competency profiles defined by an organization. The skills competency tool assesses the competency level of each employee, and for each job and competency profile, locates and maps relevant educational content, internal and external to the organization, from which personalized employee training curriculum are generated.

### PRIORITY CLAIM

This application claims the benefit of priority to U.S. provisional patent application Ser. No. 61/158,741, filed on Mar. 9, 2009.

### BACKGROUND OF THE INVENTION

1. Technical Field

This disclosure concerns a way to quickly and efficiently assess an organization's workforce capability maturity, generate a workforce transformation roadmap, and locate and map relevant educational content to job and competency profiles. In particular, this disclosure relates to an efficient and cost effective way to assess the defined job and competency profiles for an organization and the competency level of the employees of the organization. Recommended modifications to the job and competency profiles may be easily identified and personalized employee training curriculum may be generated as result.

2. Background Information

Increasingly an organization's ability to achieve targeted goals and objectives depends not only on whether the organization has a well trained workforce, but whether the organization has defined the proper jobs to achieve the targeted goals and objectives. Many organizations lack the tools necessary to ensure that the jobs managed by the organizations are properly defined so that the organizations achieve targeted goals and objectives. Globally distributed organizations face considerable challenges related to imposing and maintaining uniform standards and processes across geographically dispersed operations, diverse cultures, and varying educational levels among the workers. Organizations lack the tools to ensure that standardized processes are maintained when operations are modified, for example, due to outsourcings or relocating operations.

Because of the global demand for qualified employees, organizations must identify ways to address employee turn-over and new employee training. Significant economic challenges exist for those organizations that do not efficiently and effectively manage employee retention and development. Continuous effective training is a significant factor for increasing the productivity of an IT team. Satisfied and motivated employees are productive employees, and willing to go the extra mile for the well being of co-workers and the organization. Fewer opportunities to continue skills development are more likely to leave an employment position, even where a pay cut may be imposed as a result of leaving. In a fast-changing competitive landscape, organizations are at risk of losing core business intelligence by high employee attrition rates. Even employees reporting high satisfaction with workload, work environment and base salary are seven times more likely to consider changing employers when few opportunities to continue skills development exist. The American Society of Training and Development (ASTD) estimates that the cost to replace a professional is estimated to be 150% of the professional's annual salary, and the costs include the time to find a replacement, recruiting fees, vacancy costs, productivity losses, and training.

Organizations face considerable challenges locating educational content that is relevant to the job and competency profiles defined by the organization so that training curriculum can be developed. Often available educational content does not adequately support the job and competency profiles of an organization, because the organization assumes that particular education content teaches the requirements of the job and competency profiles. Organizations also fail to broaden the search for appropriate educational content because of the considerable task of confirming that the content teaches requisites for the job and competency profiles.

### SUMMARY

The skills competency system and method assess an organization's workforce capability maturity, recommends modifications to the organization job and competency profiles, and generates a workforce transformation roadmap. The skills competency system includes a processor and a memory coupled to the processor. The memory includes a model job framework, a competency model, a competency dictionary with model functional competency definitions, and a skills inventory with skills inventory functional competency definitions. The memory also includes current job and competency profile elements.

The model job framework comprises model job families that define model jobs for an organization to efficiently and effectively manage the organization. The model job families also define a model job and competency profile for each model job. The model job and competency profile comprises model job and competency profile elements.

The competency model comprises model functional competencies that comprise model job proficiency levels and model job skills. Model functional competency definitions and skills inventory functional competency definitions are defined for model functional competencies. The competency model also comprises competency domains in which the model functional competencies are categorized. The competency domains include a professional domain, a business domain, a process and methodology domain, and a technology and infrastructure domain.

The current job and competency profile elements for current jobs of the organization include a first job and available courses for the first job. The available courses comprise course content that teaches the model functional competencies at model job proficiency levels and model job skills.

The skills competency system includes job and competency mapping logic executed by the processor. The mapping logic locates sources of available courses comprising course content and course content elements, evaluates the course content and the course content elements to determine the course content and the course content elements that satisfy training requirements for the model job and competency profile elements. The mapping logic receives the current job and competency profile elements, and compares the current job and competency profile elements to the model functional competency definitions and the skills inventory functional competency definitions. The comparison performed by the mapping logic is used to determine a current job to model job definition gap, and a current job and competency training gap. The current job to model job definition gap, and the current job and competency training gap form a workforce transformation roadmap.

In one implementation, the skills competency system assists an organization with performing a workforce assessment, organizational alignment and right-sizing the organization. An organization may use the system to implement and maintain a talent management infrastructure, and provide learning, development and knowledge management capabilities. The system supports change management and geographical factors (e.g., learning and work culture of an organization in a given location). The skills competency system provides a workforce assessment that establishes how many people work internal and external to the organization in order to achieve the organization's goals and objectives. The people may include both employees and contractors to the organization. The skills competency system assesses the skills possessed by the people of the organization, based on current and future organizational goals and objectives. The skills competency system provides a way to align the workforce of the organization and determine the proper size of the workforce, based on determining the number of people needed to support business requirements and the forecasted kind of jobs and roles needed for the future. The skills competency system assesses whether the organization is organized properly to support the organization's operating model.

The skills competency system provides a way to establish a standard competency model and job framework for the organization's workforce. The standard competency model and job framework provide a consistent way to describe a job and the roles of the job, and provide employees a line of sight (e.g., potential career path options) for career development. The skills competency system supports knowledge transfer between experts and new hires, and may be used as an integral component to learning, development and knowledge programs for an organization, by identifying core training content for the workforce. The skills competency system may be used to support collaborations across organizational lines internal and external to the organization.

The skills competency system also supports change management by adapting job and competency profiles and training curriculum based on changes to the goals and objectives articulated by the organization. For example, when the organization modifies the operating model, goals and objectives of the organization, the skills competency system analyzes these modifications to determine recommended changes to the job and competency profiles. The skills competency system locates relevant educational content internal and external to the organization. The skills competency system maps the educational content to the job and competency profiles, and generates training curriculum based on the mapped educational content, in order to support the modified operating model and goals and objectives. To that end, organizational cultural alignment occurs through the use of the skills competency system.

Other systems, methods, and features of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the invention. Moreover, in the figures, like referenced numerals designate corresponding parts or elements throughout the different views.

FIG. 1 illustrates a skills competency system configuration.

FIG. 2 illustrates a flow diagram to determine a current job to model job definition gap, and a current job and competency training gap.

FIG. 3 illustrates a flow diagram of interactions between components of the skills competency system.

FIG. 4 illustrates skills competency components of a skills competency system.

FIG. 5 illustrates an example of a model job framework for an information technology (IT) workforce.

FIG. 6 illustrates an example of a competency model directed to the information technology industry.

FIG. 7 illustrates that the model functional competencies of the competency domains of the competency model map to the competency dictionary and the skills inventory of the skills competency system.

FIG. 8 illustrates the elements of a competency dictionary.

FIG. 9 illustrates a skills inventory.

FIG. 10 an example of a job and competency mapping of a job framework and competency model

FIG. 11 illustrates a description of a mapping of job family competencies and proficiencies.

FIG. 12 illustrates a description of job and competency profile elements.

FIG. 13 illustrates business challenges to operational performance addressed by the skills competency system.

FIG. 14 illustrates chief learning officer issues addressed by the skills competency system.

FIG. 15 illustrates potential outcomes that may result from implementing the skills competency system within an organization.

FIG. 16 illustrates components of a skills competency system.

FIG. 17 illustrates a user interface for the skills competency system.

FIG. 18 illustrates benefits of implementing the skills competency system.

FIG. 19 illustrates an Information Technology (IT) competency model.

FIG. 20 illustrates functional competencies within competency domains.

FIG. 21 illustrates group competency definitions.

FIG. 22 illustrates a mapping of skills to functional competencies within the technology and infrastructure competency domain.

FIG. 23 illustrates a further mapping of skills to functional competencies within the technology and infrastructure competency domain.

FIG. 24 illustrates another mapping of skills to functional competencies within the business competency domain.

FIG. 25 illustrates a further mapping of skills to functional competencies within the business competency domain.

FIG. 26 illustrates another mapping of skills to functional competencies within the process and methodology competency domain.

FIG. 27 illustrates a further mapping of skills to functional competencies within the process and methodology competency domain.

FIG. 28 illustrates a further mapping of skills to functional competencies within the process and methodology competency domain.

FIG. 29 illustrates a further mapping of skills to functional competencies within the process and methodology competency domain.

FIG. 30 illustrates a mapping of skills to functional competencies within the professional competency domain.

FIG. 31 illustrates chief information officer workforce related considerations.

FIG. 32 illustrates factors related to identifying, acquiring and maintaining qualified workforce talent.

FIG. 33 illustrates benefits provided by the skills competency system.

FIG. 34 illustrates exemplary skills competency benefits that may result from implementing the skills competency system.

FIG. 35 illustrates exemplary skills competency long-term benefits that may result from using the skills competency system.

FIG. 36 illustrates a summary of benefits that may result from using the skills competency system.

FIG. 37 illustrates exemplary skills competency functionality available to a user of the skills competency system.

FIG. 38 illustrates exemplary talent management assets provided by the systems management system.

FIG. 39 illustrates the logic flow the job and competency mapping logic may take to determine a current job to model job definition gap.

FIG. 40 illustrates the logic flow the workforce capability maturity tracker logic may take to generate a model job capability maturity score.

FIG. 41 illustrates the logic flow the workforce demographics assessment logic may take to identify an optional current job.

### DETAILED DESCRIPTION

The skills competency system and method assess an organization's workforce capability maturity, recommend, and generate modifications to the organization job and competency profiles, and generate a workforce transformation roadmap. The skills competency system also assesses the competency level of each employee of the organization, and for each job and competency profile, locates and maps relevant educational content, internal and external to the organization, from which the skills competency system generates personalized employee training curriculum.

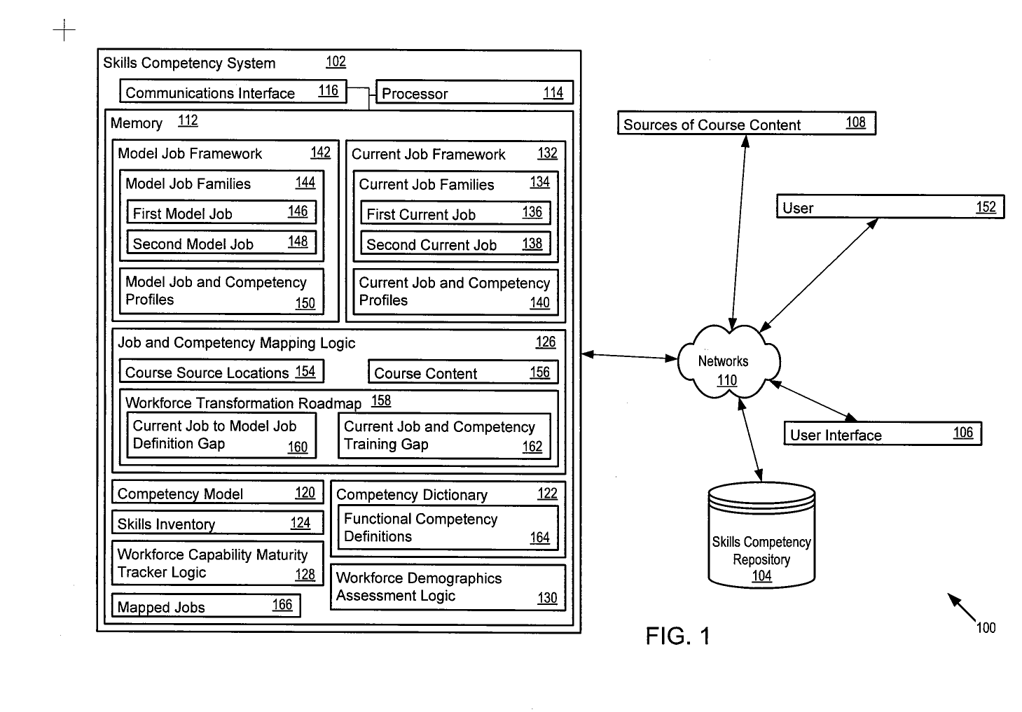

FIG. 1 illustrates a skills competency system configuration 100. The skills competency system configuration 100 includes a skills competency system 102, a skills competency database 104, a user interface 106, and various sources of information content 108 that may be used as education content. The various components of the skills competency system configuration 100 are interconnected through networks 110 (e.g., the Internet). The skills competency system 102 includes a memory 112 coupled to a processor 114, and a communications interface 116. The memory 112 includes a model job framework 142, a competency model 120, a competency dictionary 122 that includes a functional competency definition 164, and skills inventory 124. The memory also includes job and competency mapping logic 126, workforce capability maturity tracker logic 128, and workforce demographics assessment logic 130 that the processor 114 executes.

In one implementation, the skills competency system 102 includes a current job framework 132 comprising current job families 134. The current job families 134 include multiple current job families, each of which may include one or more current jobs (e.g., a current first job 136 and a second current job 138). Each current job (e.g., 136 and 138) comprising current job and competency profiles 140 with profile elements. In one implementation, the profile elements of the current job and competency profiles 140 include: a current job title; a current job summary that summarizes the purpose and responsibilities of the current job; current job responsibilities; forecasted current job career roles a person holding the current job may be assigned during the career of the person; and current competencies and proficiency levels a person may possess to adequately fulfil the responsibilities of the current job. In another implementation, the current job framework 132 may include other combinations of current job families, and current jobs comprising other current job and competency profiles with different profile elements, as desired to meet the current implementation goals of the organization.

The memory 112 also includes a model job framework 142 comprising model job families 144. The model job families 144 include multiple model job families, each of which may include one or more model jobs (e.g., a model first job 146 and a model second job 148). Each model job (e.g., 146 and 148) comprising model job and competency profiles 150 with profile elements. In one implementation, the profile elements of the model job and competency profiles 150 include: a model job title; a model job summary that summarizes the purpose and responsibilities of the model job; model job responsibilities; forecasted model job career roles a person holding the model job may be assigned during the career of the person; and model competencies and proficiency levels a person may possess to adequately fulfil the responsibilities of the model job. In another implementation, the model job framework 142 may include other combinations of model job families, and model jobs comprising other model job and competency profiles with different profile elements, as desired to meet the current implementation goals of the organization.

Referring briefly to Table 1, an exemplary model job and competency profile for a model job entitled “Application Engineer” may include a job summary, key responsibilities, and representative roles. The key responsibilities for the Application Engineer, as shown in Table 1, include requirements management, application development, and application implementation and maintenance. The representative roles, shown in Table 1, include project roles including application maintenance specialist. The model job and competency profile shown in Table 1 is exemplary only, for example, the Application Engineer model job may be defined in other ways in other implementations.

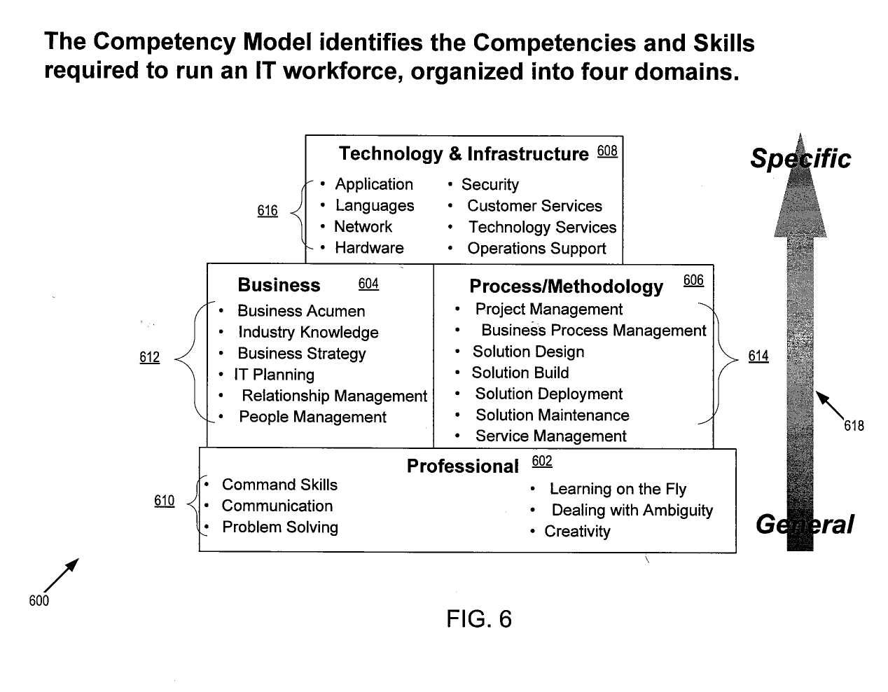

Referring briefly to Table 2, the model job and competency profile elements may further include competencies with proficiency levels and proficiency descriptions. The competencies may be categorized according to the competency domains of the competency model 120, discussed in detail below (see FIG. 6), including a professional competency, a business competency, a process and methodology competency, and a technology and infrastructure competency. The model job and competency profile elements shown in Table 2 are exemplary only, for example, the model job and competency profile elements may be defined in other ways in other implementations.

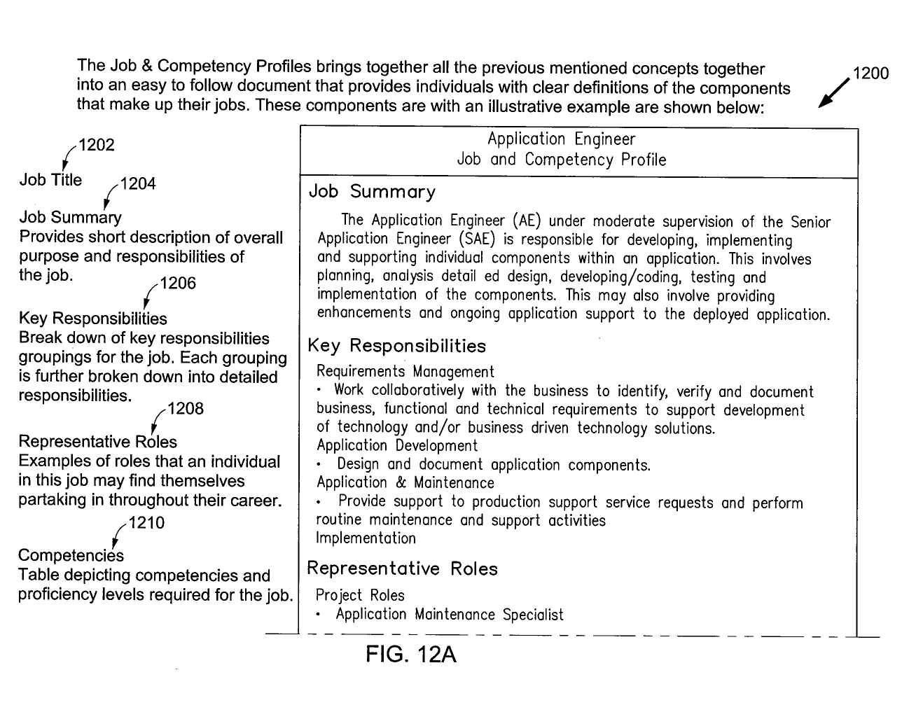

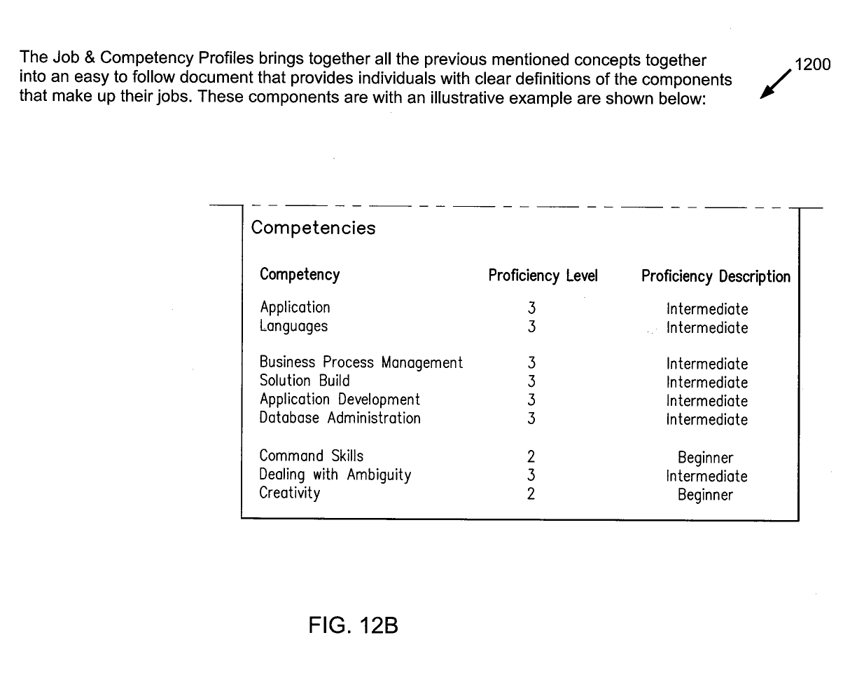

FIG. 12 illustrates a description of job and competency profile elements 1200, as illustrated in further detail below in Tables 1 and 2. The job and competency profile elements include a job title 1202, a job summary 1204, key responsibilities 1206, representative roles 1208, and competencies 1210.

Returning to FIG. 1, the skills competency system 102 communicates with the skills competency database 104 via the network 110. The skills competency database 104 stores the model job framework 142, the model job and competency profiles 144, the competency model 120, the competency dictionary 122, the skills inventory 124, the current job framework 132, and the current job and competency profiles 140.

The skills competency system 102 may receive user input and query requests from a user 152 (e.g., skills competency administrator, employee and/or contractor) through the user interface 106. The skills competency system 102 also displays job and competency mapping logic 126 results to the user 152 via the user interface 106. The job and competency mapping logic 126 results may include course source location 154 and course content 156 identified from the sources of course content 108. The skills competency system 102 also displays a workforce transformation roadmap 158 to the user 152 via the user interface 106. The workforce transformation roadmap 158 may include current job to model job definition gap 160, a current job and competency training gap 162, and mapped jobs 166, described in detail below.

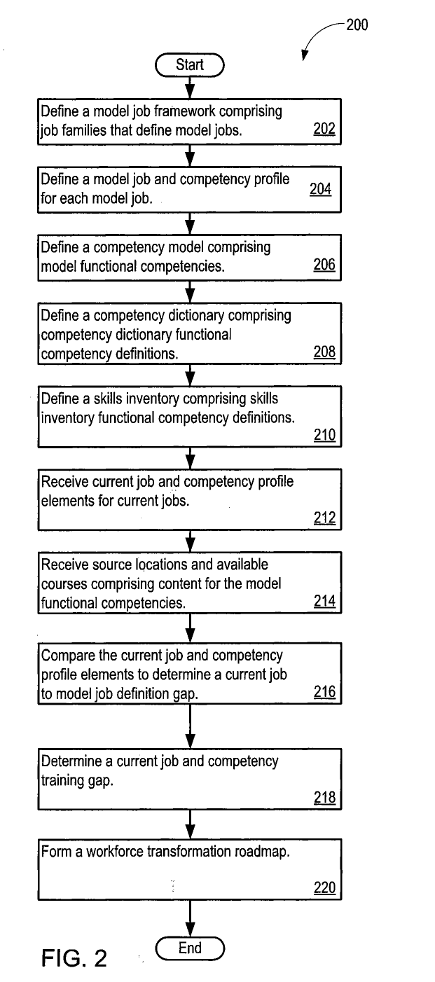

FIG. 2 illustrates a flow diagram 200 to determine a current job to model job definition gap 160, and a current job and competency training gap 162. In one implementation, the skills competency system 102 defines a model job framework 142 comprising model job families 144 that define model jobs (e.g., 146 and 148) (202). In another implementation, a skills competency administrator defines the model job framework 142 via the user interface 106 and stores the model job framework 142 in the skills competency database 104. The skills competency system administrator may be a learning administrator and/or chief learning officer of the organization. The model job framework 142 comprises model jobs (e.g., 146 and 148) that each define model job and competency profiles 150 that include profile elements. In one implementation, the skills competency administrator defines the model jobs (e.g., 146 and 148) (204), including the model job and competency profiles 150 and profile elements. The model job and competency profile elements may include: a model job title; a model job summary that summarizes the purpose and responsibilities; model job responsibilities; forecasted model job career roles that a person holding the model job may be assigned during the career of the person; and model competencies and proficiency levels that a person may possess to adequately fulfil the responsibilities of the model job. The skills competency administrator may define the competency model 120 comprising model functional competencies (206).

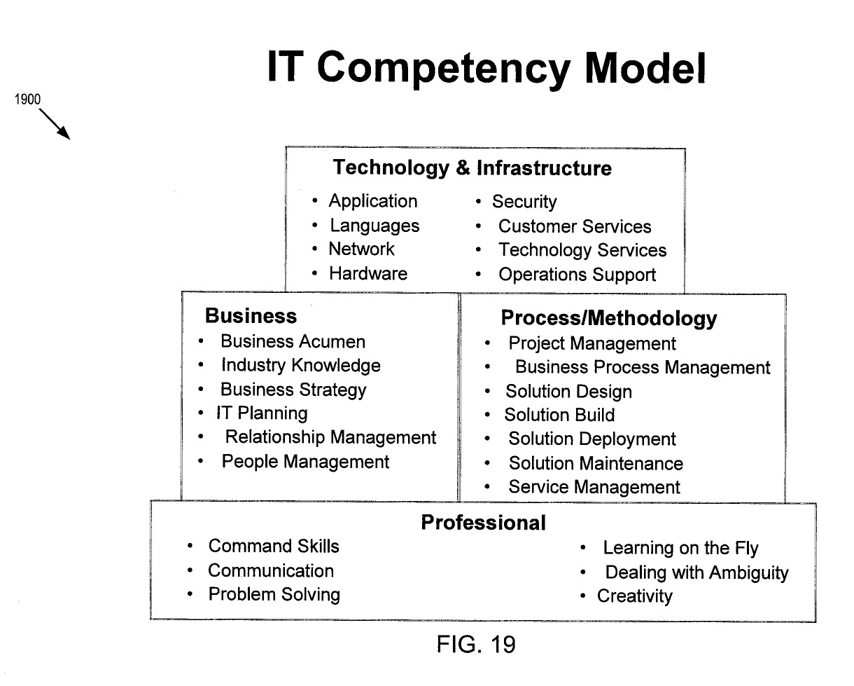

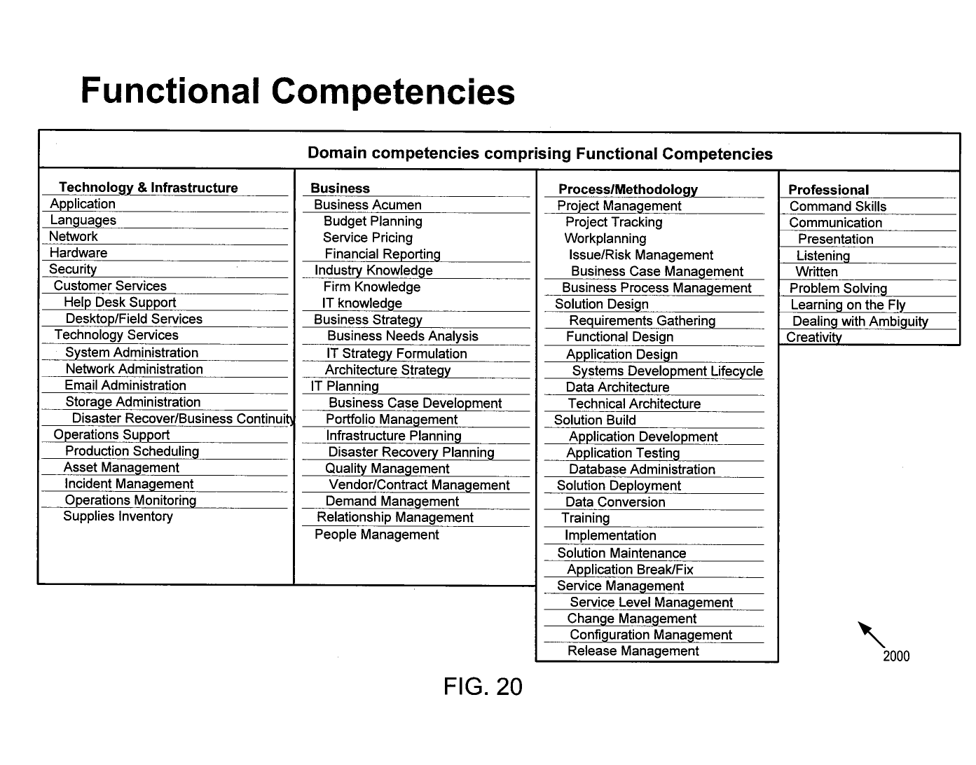

Referring briefly to FIG. 6, an information technology (IT) competency model 600 with competency domains (e.g., 602, 604, 606, and 608) directed to the information technology industry are shown. FIG. 19 also illustrates the IT competency model 600 shown in FIG. 6. The competency model 120 is used as a general example, whereas the IT competency model 600 is a specific example directed to the IT industry. The IT competency model 600 defines competencies, organized into competency domains and skills that may be needed to optimally operate and manage an IT workforce. In one implementation, the competency domains for the IT industry include: a professional 602 domain, a business 604 domain, a process/methodology 606 domain, and a technology and infrastructure 608 domain. The competency domains (e.g., 602, 604, 606, and 608) comprise model functional competencies (e.g., 610, 612, 614, and 616). For comparison, FIG. 20 illustrates another arrangement of functional competencies 2000 for an IT model competency.

In one implementation, the model functional competencies of the professional 602 competency domain include: command skills; communications; problem solving; learning on the fly; dealing with ambiguity; and creativity. The model functional competencies of the business 604 competency domain include: business acumen; industry knowledge; business strategy; IT planning; relationship management; and people management. The model functional competencies of the process/methodology 606 competency domain include: project management; business process management; solution design; solution build; solution deployment; solution maintenance; and service management. The model functional competencies of the technology and infrastructure 608 domain include: an application competency; a languages competency; a network competency; a hardware competency; a security competency; a customer services competency; a technology services competency; and an operations support competency. In one implementation, the competency domains are arranged from general competencies to more specific competencies, as shown by the arrow 618.

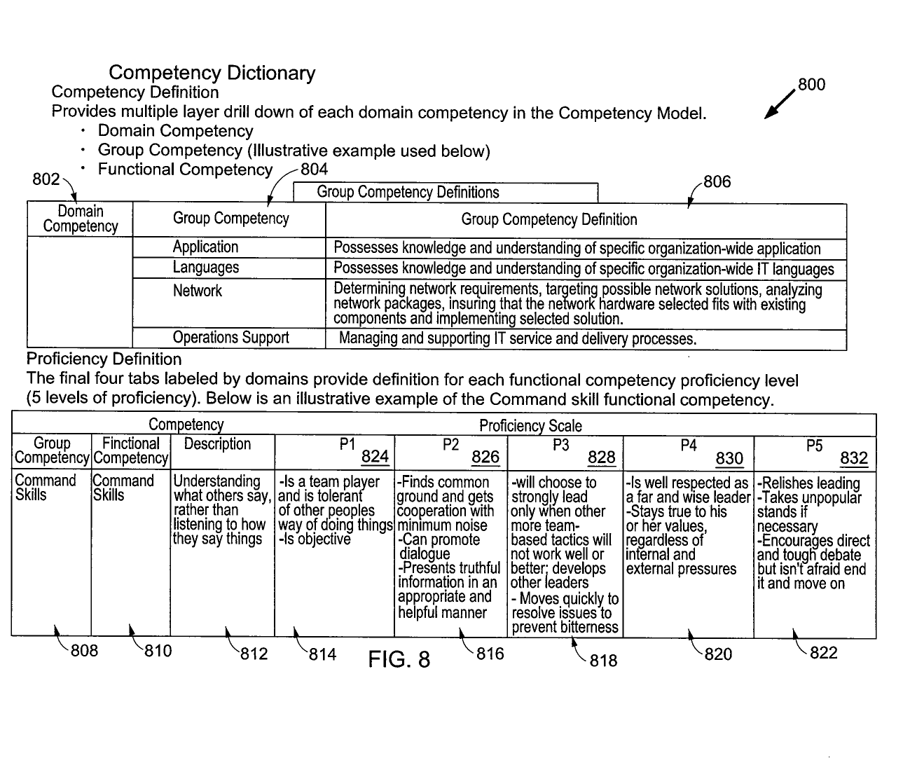

Returning to FIG. 2, the skills competency administrator may define the competency dictionary 122 (208). The competency dictionary 122 comprises model functional competency definitions 164 that comprise: a functional competency description; proficiency levels; and model proficiency level definitions that define the criteria for each model proficiency level. The competency dictionary 122 is described in detail below (See FIG. 8).

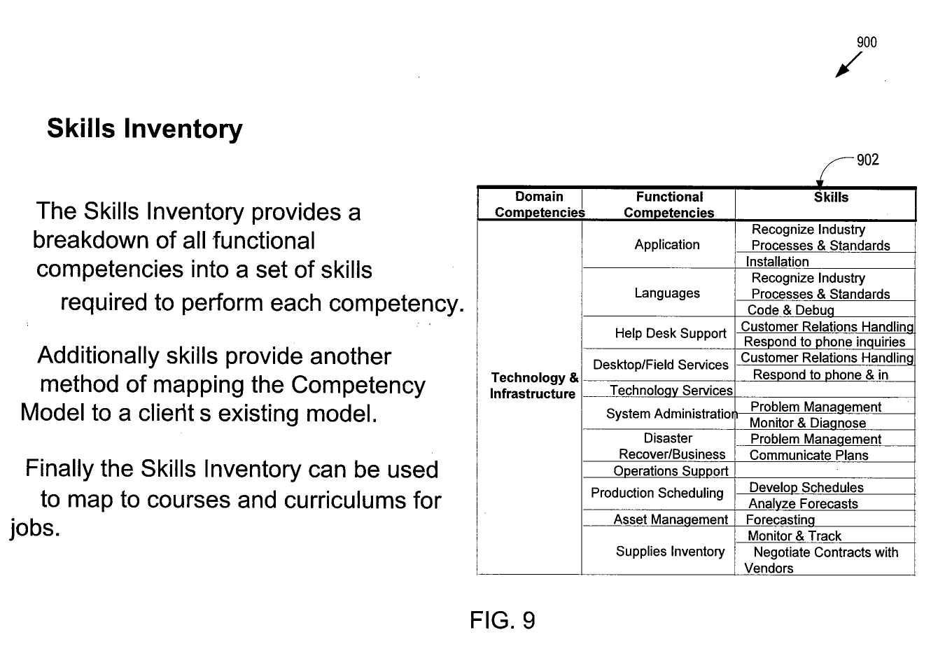

The skills competency administrator defines the skills inventory 124 (210). The skills inventory 124 comprises skills inventory functional competency definitions that each comprises a model functional competency decomposition of skills for each model functional competency. In one implementation, the skills inventory 124 may be derived from past projects and used to identify a skills list for each functional competency. The skills inventory 124 is described in detail below (See FIG. 9).

The skills competency system 102 receives current job and competency profile elements for current jobs (e.g., 136 and 138) from the skills competency administrator (212). Alternatively, the skills competency system 102 receives current job and competency profile elements for a particular current job (e.g., 136 and 138) from a user 152. For example, an employee with a particular current job (e.g., 136 and 138) may input the current job and competency profile elements to determine a current job to model job definition gap 160 and a current job and competency training gap for the particular current job 162.

In one implementation, the skills competency system 102 receives content source locations 154 and available courses comprising course content 156 for the model functional competencies (e.g., 610, 612, 614, and 616) (214). The job and competency mapping logic 126 locates sources of available courses comprising course content and course content elements, evaluates the course content and the course content elements to determine the course content and the course content elements satisfy training requirements for the model job and competency profile elements. The skills competency system 102 analyzes the model functional competency definitions 164 and skills inventory functional competency definitions in order to develop searches for content and courses from which to generate curriculum. Curriculum may comprise content and courses usable to learn skills identified by the skills inventory functional competency definitions that map to functional competencies. In one implementation, the skills competency system 102 includes job and competency mapping logic 126 configured to determine a current job to model job definition gap 160 (216).

The job and competency mapping logic 126 determines a job and competency training gap 162 for a person assigned a current job (e.g., 136 and 138), where the current job is identified as a mapped job 166 (218). The job and competency training gap 162 includes competency and proficiency level deficiencies for current job and model functional competencies. In other words, the job and competency training gap 162 may identify competency and proficiency level deficiencies for each person assigned a current job, and competency and proficiency level deficiencies for the current job as defined in view of a model job to which the current job maps. In this way, an organization can identify minimal training for a person assigned a particular current job so that the current job as defined and the person assigned the job may move toward the competency and proficiency levels defined by the model job to which the current job maps. The job and competency mapping logic 126 may use the job and competency training gap 162 to identify a personalized training curriculum for each person in the workforce. The personalized training curriculum may comprise selected courses from the available courses, including the course source location 154 and course content 156.

In one implementation, the skills competency system 102 generates a workforce transformation roadmap 158 that includes a new jobs definition project plan (220). The new jobs definition project plan may comprise a schedule and cost estimates to establish new job definitions, based on the current job to model job definition gap 160. The workforce transformation roadmap 158 may include a training project plan comprising a schedule and cost estimates to train persons assigned current jobs, based on the current job and competency training gap 162 and the personalized training curriculum for each person.

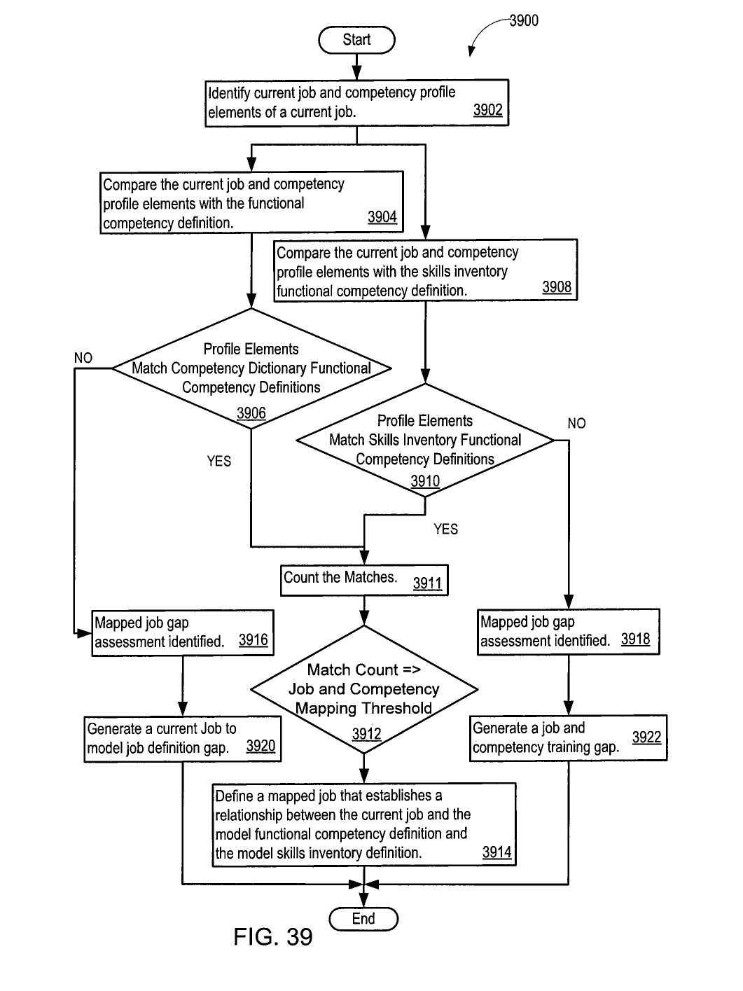

Referring briefly to FIG. 39, the logic flow 3900 the job and competency mapping logic 126 may take to determine a current job to model job definition gap is illustrated. The job and competency mapping logic 126 locates sources of available courses comprising course content and course content elements, evaluates the course content and the course content elements to determine the course content and the course content elements satisfy training requirements for the model job and competency profile elements. The job and competency mapping logic 126 identifies current job and competency profile elements of a current job (e.g., 136 and 138) (3902) that match all or a portion of a functional competency definition in the competency dictionary 122 (3904) (3906) (3911) and all or a portion of a skills inventory functional competency definition in the skills inventory 124 (3908) (3910) (3911). In one implementation, the job and competency mapping logic 126 identifies current job and competency profile elements of a current job (e.g., 136 and 138) (3902) that match all or a portion of the model job and competency profile elements 150 (3904) (3906) (3911) and all or a portion of a skills inventory functional competency definition in the skills inventory 124 (3908). A mapped job 166 may be determined based on the number of current job and competency profile elements of a current job (e.g., 136 and 138) matching all or a portion of a functional competency definition in the competency dictionary and all or a portion of a skills inventory functional competency definition in the skills inventory that exceed a job and competency mapping threshold value (3912). A mapped job 166 defines a relationship between a current job (e.g., 136 and 138) and a model functional competency definition 164 and a skills inventory functional competency definition so that the current job and competency profile may be assessed and modified (3914). In one implementation, the skills competency system administrator specifies the job and competency mapping threshold value. In one implementation, the job and competency mapping logic 126 determines whether a current job (e.g., 136 and 138) and at least one of the model functional competency definitions 164 and at least one of the skills inventory functional competency definitions match the job and competency mapping threshold value, and generates a mapped job gap assessment that comprises difference job and competency profile elements. The difference job and competency profile elements identify elements of the current job and the functional competency definitions and the skills inventory functional competency definitions that do not match.

The job and competency mapping logic 126 identifies a mapped job gap assessment for the current job and competency profile elements of a current job (e.g., 136 and 138) that do not match the model functional competency definitions and the skills inventory functional competency definitions (3916) (3918). In one implementation, the job and competency mapping logic 126 uses the mapped job gap assessment to generate the current job to model job definition gap 160 (3920) for each current job (e.g., 136 and 138), and a job and competency training gap 162 (3922). In one implementation, the job and competency mapping logic 126 generates the workforce transformation roadmap 158 using the current job to model job definition gap 160 and the job and competency training gaps 162.

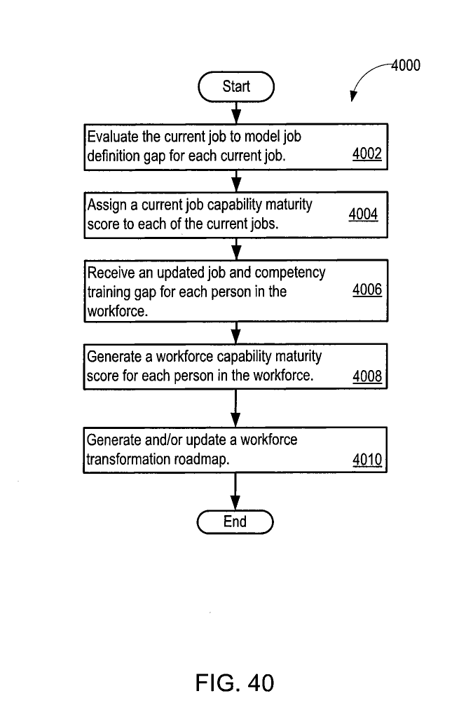

Referring briefly to FIG. 40, the logic flow 4000 the workforce capability maturity tracker logic 128 may take to generate a model job capability maturity score is illustrated. The workforce capability maturity tracker logic 128 generates a model job capability maturity score for each of the model jobs (e.g., 146 and 148). The workforce capability maturity tracker logic 128 may use the model job capability maturity score for the model jobs (e.g., 146 and 148) to determine a capability maturity score for the model job framework 142. The workforce capability maturity tracker logic 128 evaluates the current job to model job definition gap 160 (4002), and for each of the current jobs (e.g., 136 and 138), assigns a current job capability maturity score (4004) based on the number of current job and competency profile elements of a current job (e.g., 136 and 138) that match all or a portion of a functional competency definition in the competency dictionary and all or a portion of a skills inventory functional competency definition in the skills inventory. In one implementation, the current job capability maturity score indicates how closely a current job matches a model job based on a scale of 0% to 100% matching. The workforce capability maturity tracker logic 128 may use the current job capability maturity score for the current jobs (e.g., 136 and 138) to determine a capability maturity score for the current job framework 132. In one implementation, the workforce capability maturity tracker logic 126 receives an updated job and competency training gap that identifies the courses completed and experience reported by the person, supervisors and management (4006) for each of the personalized training curriculum. The workforce capability maturity tracker logic 128 generates a workforce capability maturity score for each person assigned a current job (e.g., 136 and 138), and/or each person identified in the organization's workforce (e.g., user 152), based on the courses completed and experience reported by the person, supervisors and managers for each of the personalized training curriculum (4008). In one implementation, the workforce capability maturity tracker logic 128 generates and/or updates the workforce transformation roadmap 158 using the courses completed and experience reported by each person, supervisors and managers for each of the personalized training curriculum (4010).

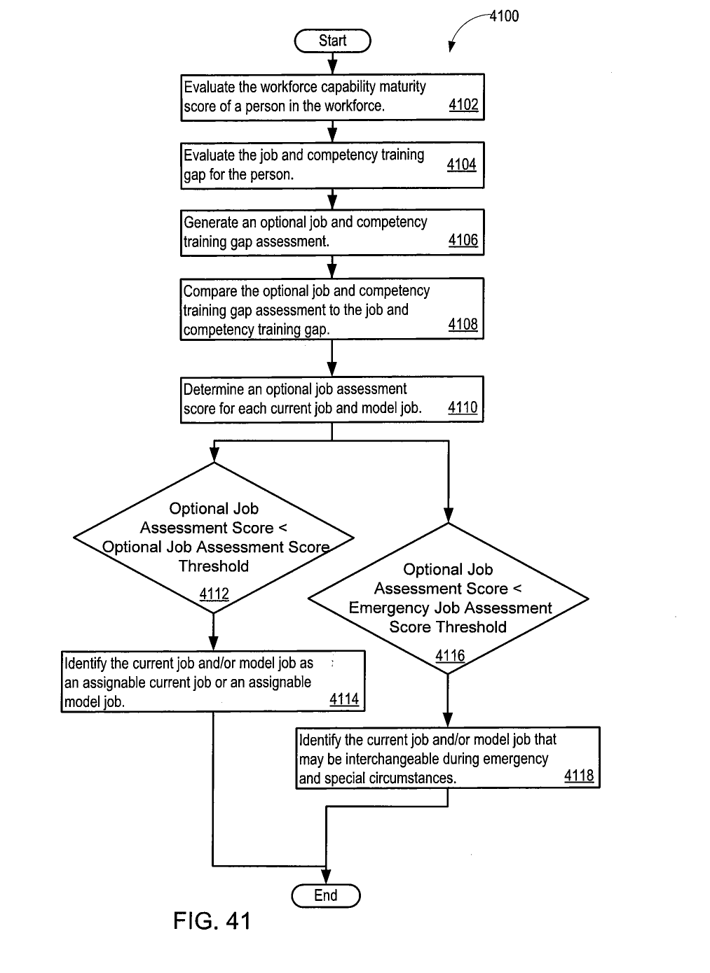

Referring briefly to FIG. 41, the logic flow 4100 the workforce demographics assessment logic may take to identify an optional current job is illustrated. The workforce demographics assessment logic 130 identifies an optional current job that requires similar qualifications as a current job (e.g., 136 and 138) and/or model job (e.g., 146 and 148). The workforce demographics assessment logic 130 may evaluate the workforce capability maturity score of a person in the organization's workforce (4102) and the job and competency training gap 162 for the person (4104). In one implementation, the workforce demographics assessment logic 130 generates, for each person in the workforce, an optional job and competency training gap assessment for the current jobs and model jobs defined in the current job framework and model job framework (4106) and compares the optional job and competency training gap assessment to the job and competency training gap 162 for each person (4108) to determine an optional job assessment score for each current job and model job (4110). When the optional job assessment score for the corresponding current job and/or model job is below a configurable optional job assessment score threshold (4112), the workforce demographics assessment logic 130 identifies a current job and/or a model job as an assignable current job or an assignable model job, respectively (4114). In one implementation, when the optional job assessment score is below a configurable emergency job assessment score threshold (4116), the workforce demographics assessment logic 130 identifies current jobs and/or model jobs that may be interchangeable during emergency and special circumstances (4118) so that an organization can develop emergency plans (e.g., union strikes and disasters). The emergency job assessment score threshold may be set to a value higher than the optional job assessment score threshold.

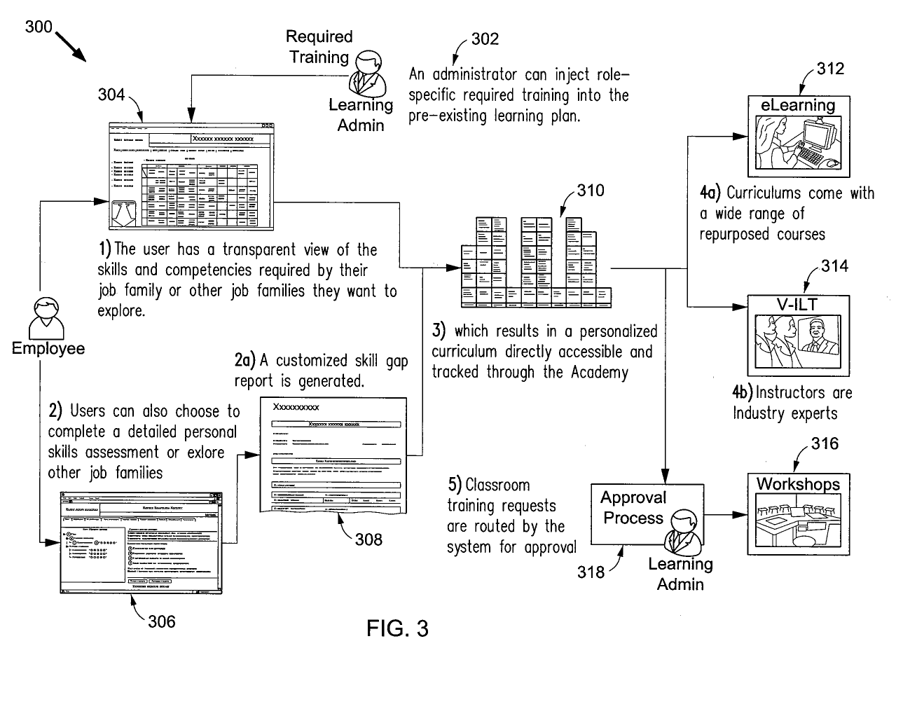

FIG. 3 illustrates a flow diagram 300 of interactions between components of the skills competency system 102. The skills competency system administrator defines specific training for model jobs (e.g., 146 and 148) within the model job framework 142 (302). The skills competency system 102 provides the employee (e.g., user 152) a transparent view of the skills and competencies defined for the employee's job family (e.g., current job families 134) (304). The employee (e.g., user 152) may use the skills competency system 102 to also explore other job families (e.g., 142 and 134) of interest to plan training and potential career progressions (306). In one implementation, the job and competency mapping logic 126 presents a user interface 106 for the employee (e.g., user 152) to conduct a personal skills assessment and compare the personal skills assessment against a current job and other jobs within other job families of interest (308). The job and competency mapping logic 126 generates and displays a job gap assessment for the current job (e.g., 136 and 138) and/or the other jobs (e.g., 136, 138, 146, and 148) within other job families of interest. The job and competency mapping logic 126 generates and displays a personalized training curriculum for the employee (e.g., user 152) (310). The personalized training curriculum may include courses that are internal and/or external to the organization. The courses may be self-paced (312) and/or lead by an instructor (314 and 316). The skills competency system 102 tracks the completion of the personalized training curriculum by the employee (e.g., user 152). The employee identifies a training component defined by the personalized training curriculum, and submits a request to a skills competency system administrator for approval of the training component (318).

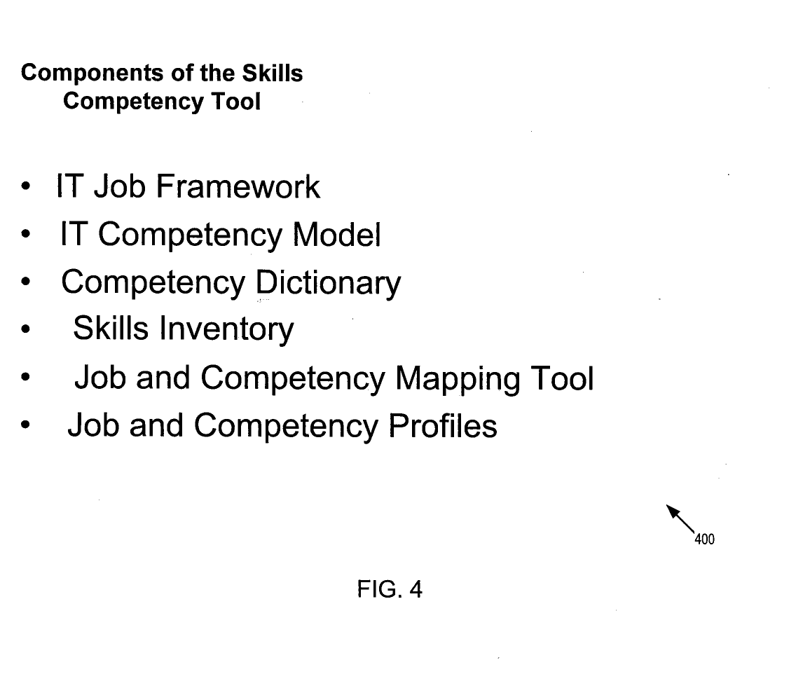

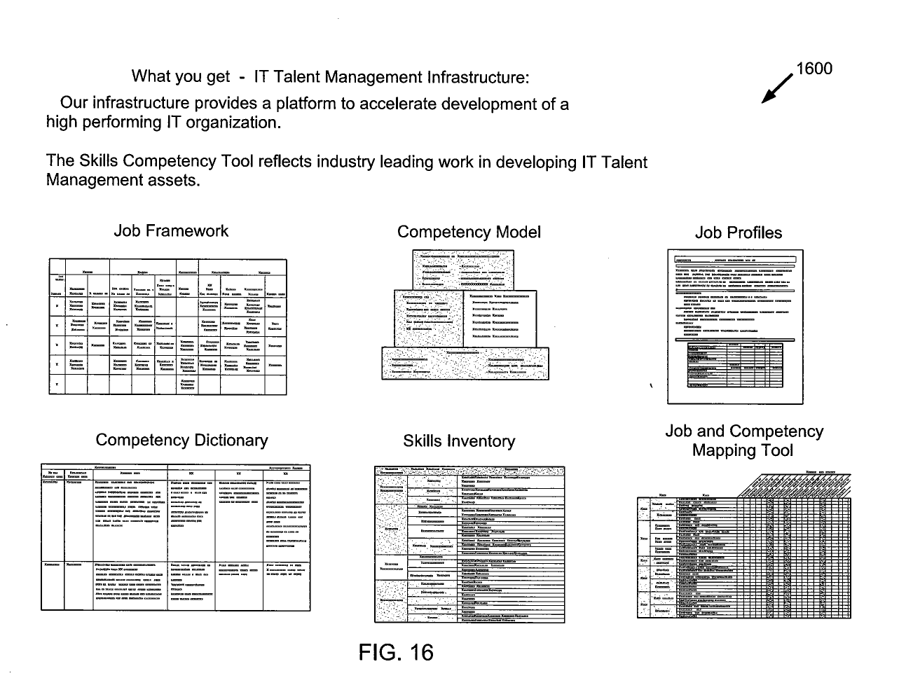

FIG. 4 illustrates skill competency components 400 of a skills competency system 102 directed to Information Technology (IT), including: an IT job framework (e.g., 142); an IT competency model (e.g., 600); a competency dictionary 122; a skills inventory 124; a job and competency mapping tool (e.g., the job and competency mapping logic 126); and job and competency profiles (e.g., model job and competency profiles 150). For comparison, FIG. 16 further illustrates components 1600 of the skills competency system 102. In one implementation, the components 1600 of the skills competency system 102 include: a job framework (e.g. 132 and 142); a competency model 120; job profiles (e.g., 140 and 150); a competency dictionary 122; a skills inventory 124; and a job and competency mapping tool (e.g., job and competency mapping logic 126).

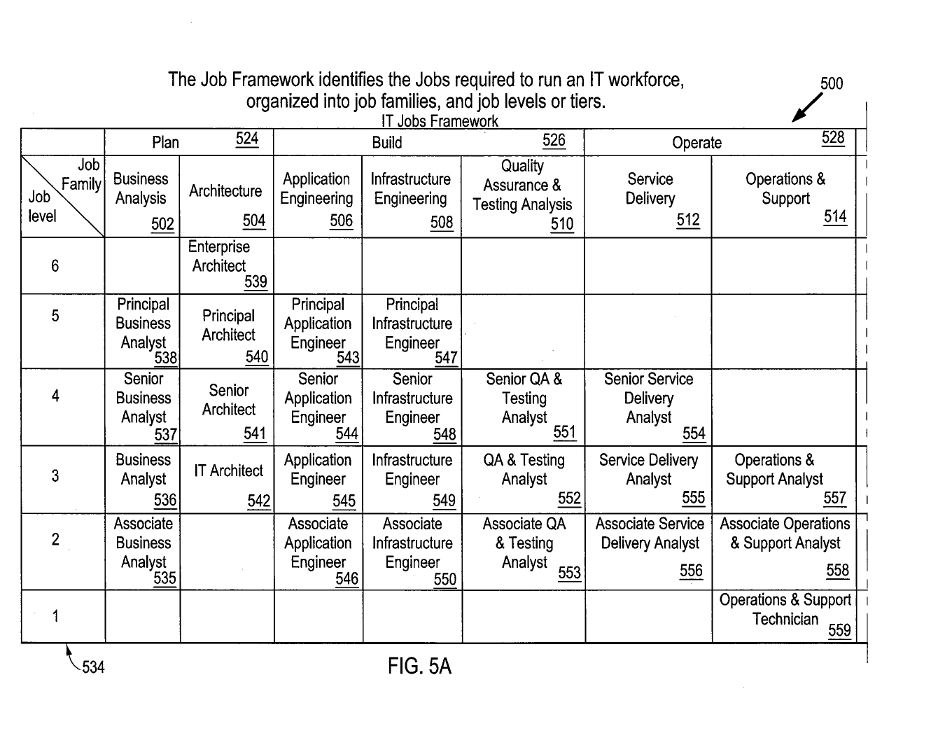

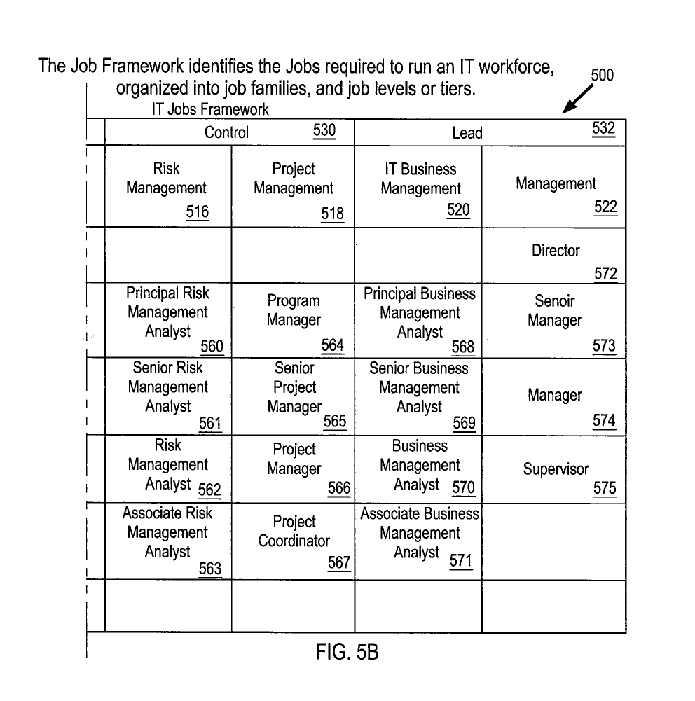

FIG. 5 illustrates an example of the model job framework 500 for an information technology (IT) workforce. The model job framework 500 comprises model job families (e.g., 502, 504, 506, 508, 510, 512, 514, 516, 518, 520, and 522) that define model jobs that an organization may use to manage the organization. In one implementation, the model job framework 500 includes the following job family types: plan 524; build 526; operate 528; control 530; and lead 532. The job family types may comprise job families that define family jobs and family job levels for each family job.

The job families (e.g., 502, 504, 506, 508, 510, 512, 514, 516, 518, 520, and 522) define family jobs and family job levels 534 (e.g., job levels 1 through 6) for each family job. The family job levels may be used to indicate an ordered progression from a first family job (e.g., associate business analyst 535) within a job family to a successive second family job (e.g., business analyst 536) within the same job family. The family job levels 534 may be used to also indicate an ordered authority of management reporting so that family jobs assigned a lower family job level (e.g., job level 1) report to and/or are managed by higher family job levels (e.g., job levels 2 through 6).

In one implementation, the job family type plan 524 includes the business analysis 502 and an architecture 504 job families. The business analysis 502 job family includes a principal business analyst job 538 assigned a family job level of 5, a senior business analyst job 537 assigned a family job level of 4, business analyst job 536 assigned a family job level of 3, and an associate business analyst job 535 assigned a family job level of 2. The architecture 504 job family includes an enterprise architect 539 job assigned a family job level of 6, a principal architect 540 job assigned a family job level of 5, a senior architect 541 job assigned a family job level of 4, and an IT architect 542 job assigned a family job level of 3.

In one implementation, the job family type build 526 includes the application engineering 506, the infrastructure engineering 508, and the quality assurance and testing analysis 510 job families. The application engineering 506 job family includes a principal application engineer 543 job assigned a family job level of 5, a senior application engineer 544 job assigned a family job level of 4, an application engineer 545 job assigned a family job level of 3, and an associate application engineer 546 job assigned a family job level of 2. The infrastructure engineering 508 job family includes a principal infrastructure engineering 547 job assigned a family job level of 5, a senior infrastructure engineering 548 job assigned a family job level of 4, an infrastructure engineering 549 job assigned a family job level of 3, and an associate infrastructure engineering 550 job assigned a family job level of 2. The quality assurance (QA) and testing analysis 510 job family includes a senior QA and testing analyst 551 job assigned a family job level of 4, a QA and testing analyst 552 job assigned a family job level of 3, and an associate QA and testing analyst 553 job assigned a family job level of 2.

In one implementation, the job family type operate 528 includes the service delivery 512 and the operations and support 514 job families. The service delivery 512 job family includes a senior service delivery analyst 554 job assigned a family job level of 4, a service delivery analyst 555 job assigned a family job level of 3, and an associate service delivery analyst 556 job assigned a family job level of 2. The operations and support 514 job family includes an operations and support analyst 557 job assigned a family job level of 3, an associate operations and support analyst 558 job assigned a family job level of 2, an operations and support technician 559 job assigned a family job level of 1.

In one implementation, the job family type control 530 includes the IT risk management 516 and the project management 518 job families. The IT risk management job family includes a principal risk management analyst 560 job assigned a family job level of 5, a senior risk management analyst 561 job assigned a family job level of 4, a risk management analyst 562 job assigned a family job level of 3, and a associate risk management analyst 563 job assigned a family job level of 2. The project management 518 job family includes a program manager 564 job assigned a family job level of 5, a senior project manager 565 job assigned a family job level of 4, a project manager 566 job assigned a family job level of 3, and a project coordinator 567 job assigned a family job level of 2.

In one implementation, the job family type lead 532 includes the IT business management 520 and the management 522 job families. The IT business management 520 job family includes a principal business management analyst 568 job assigned a family job level of 5, a senior business management analyst 569 job assigned a family job level of 4, a business management analyst 570 job assigned a family job level of 3, and an associate business management analyst 571 job assigned a family job level of 2. The management 522 job family includes a director 572 job assigned a family job level of 6, a senior management 573 job assigned a family job level of 5, a manager 574 job assigned a family job level of 4, and a supervisor 575 job assigned a family job level of 3.

Tables 1 and 2 illustrate the application engineer job and competency profiles and corresponding detailed descriptions of the profile elements, as shown in FIG. 5. The job and competency profiles shown in Tables 1 and 2 are exemplary only, and jobs may be defined in other ways in other implementations.

TABLE 1
Application Engineer
Job and Competency Profile

Job Summary
The Application Engineer (AE) under moderate supervision of the Senior
Application Engineer (SAE) is responsible for developing, implementing and
supporting individual components within an application. This involves planning,
analysis, detailed design, developing/coding, testing and implementation of the
components. This may also involve providing enhancements and ongoing
application support to the deployed application.
The AE adheres to the established lifecycle methodology and practices, in
accordance to project plans while carrying out their responsibilities. This may
include maintaining program libraries and technical documentation of the individual components
within an application.
Key Responsibilities
Requirements Management
Work collaboratively with the business, use established requirements
management methodology and tools, to identify, verify and document
business, functional and technical requirements to support development of
technology and/or business-driven technology solutions.
Assist SAE in defining business solutions, ensuring alignment with business
strategies and priorities, as well as the target benefits expected.
Work with other AEs to ensure that the modified application components
interact appropriately, data conversion impacts are considered, and other
areas of impact are addressed.
Identify new hardware/software technologies to fit specialized business
needs and configurations.
Application Development
Design and document application components.
Direct the development and configuration of application components from
conceptualization through stabilization using various computer platforms.
Provide leadership and technical guidance to Associate Application
Engineers in project management, planning, estimating, reporting,
scheduling, and workflow.
Test, debug and document components of an application.
Application Implementation & Maintenance
Implement application components by analyzing the current system
environment, using technical tools and utilities, performing complex product
customization, and developing implementation and verification procedures to
ensure successful installation of systems hardware/software.
Provide support to production support service requests and perform routine
maintenance and support activities
Representative Roles
Project Roles
Application Maintenance Specialist

TABLE 2
Appication Engineer - Competency Profile

| | | |
|---|---|---|
| | | Proficiency |
| Competency | Proficiency Level | Description |

Technology & Infrastructure

| | | |
|---|---|---|
| Application | 3 | Intermediate |
| Languages | 3 | Intermediate |

Process/Methodology

| | | |
|---|---|---|
| Business Process | 3 | Intermediate |
| Management | | |
| Solution Design | | |
| Requirements Gathering | 3 | Intermediate |
| Functional Design | 3 | Intermediate |
| Application Design | 3 | Intermediate |
| Systems Development | 3 | Intermediate |
| Lifecycle | | |
| Data Architecture | 3 | Intermediate |
| Technical Architecture | 3 | Intermediate |
| Solution Build | | |
| Application Development | 3 | Intermediate |
| Application Testing | 3 | Intermediate |
| Database Administration | 3 | Intermediate |
| Solution Maintenance | | |
| Application Break/Fix | 3 | Intermediate |

Professional

| | | |
|---|---|---|
| Command Skills | 2 | Beginner |
| Communication | | |
| Presentation | 3 | Intermediate |
| Listening | 3 | Intermediate |
| Written | 3 | Intermediate |
| Problem Solving | 3 | Intermediate |
| Learning on the Fly | 2 | Beginner |
| Dealing with Ambiguity | 3 | Intermediate |
| Creativity | 2 | Beginner |

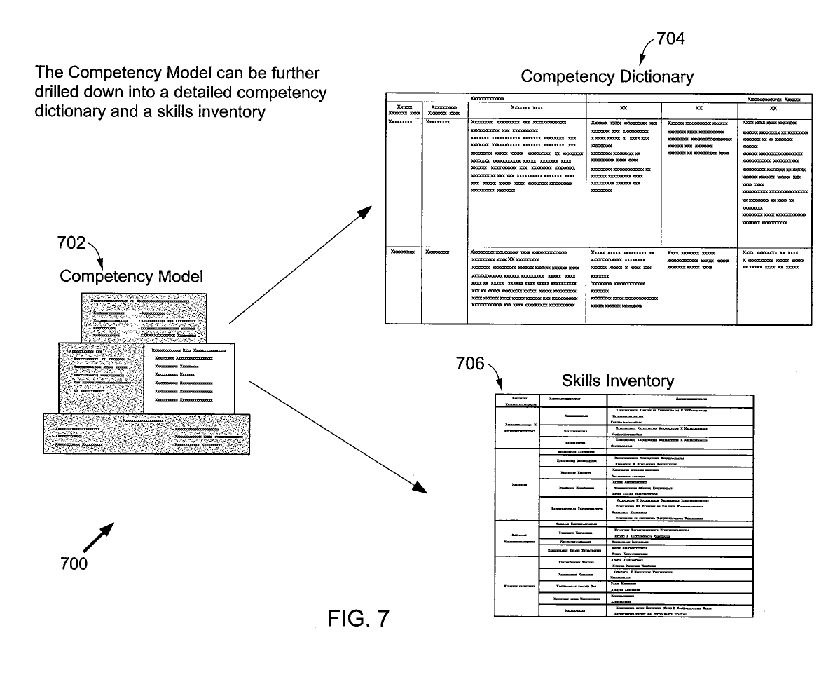

FIG. 7 illustrates that the model functional competencies (e.g., 610, 612, 614, and 616) of the competency domains (e.g., 602, 604, 606, and 608) of the competency model 702 (e.g., 120 and 600) map to the competency dictionary 704 (e.g., 122) and the skills inventory 706 of the skills competency system 102.

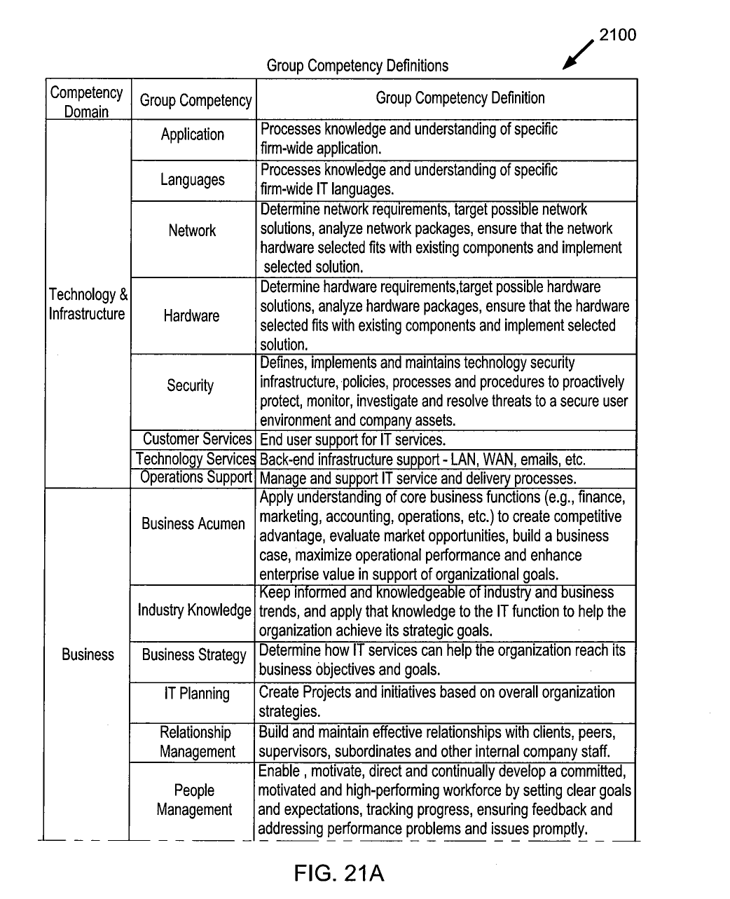

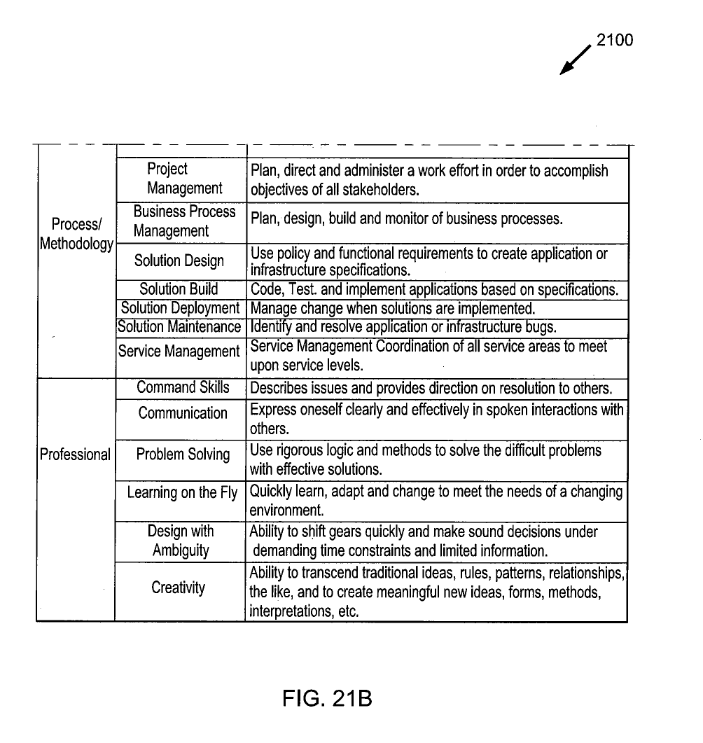

FIG. 8 illustrates the elements of a competency dictionary 800. A competency is a characteristic that contributes distinguishably to the successful performance of a specific job. Identifying appropriate competencies for a job profile make the difference between excellent and good performance outcomes for a person assigned the particular job. The competency domains 802 comprise one or more group competencies 804 and corresponding group competency definitions 806. In one implementation, the competency domains 802 correspond to the competency model domains (e.g., 602, 604, 606, and 608), discussed in further detail below (See FIG. 21). In one implementation, a group competency (e.g., 804 and 808) comprises a functional competency 810 and competency description 812, as well as detailed proficiency level descriptions (e.g., 814, 816, 818, 820 and 822) that correspond to proficiency levels (e.g., 824, 826, 828, 830 and 832), respectively. The group competency 804 may be used to communicate and teach the details of a competency model 120 and perform a complete competency assessment across an organization. The functional competencies 810 and proficiency level descriptions (e.g., 814, 816, 818, 820 and 822) may be used to prepare a training development plan and assess the proficiency of a person for a particular job. The competency dictionary 122 may be used by managers and supervisors of an organization as a tool to help assess and develop individuals and teams.

A complement proficiency dictionary may be used to support the competency dictionary 122. In one implementation, the proficiency dictionary comprises all the functional competencies 810 for an organization and defines what proficiency level (e.g., 824, 826, 828, 830 and 832) of skills and experience an individual needs to possess and/or perform in order to achieve a level of proficiency in a competency. The proficiency levels (e.g., 824, 826, 828, 830 and 832) may be defined ranging from newly trained to an expert in the field. In one implementation, the proficiency levels include: trained; beginner; intermediate; advanced; and expert. The trained proficiency level indicates that an individual has been trained in the skills that make up the competency and/or has limited practical experience, and the individual has a general understanding of the theory and application of the competency. The beginner proficiency level indicates that an individual has had some practical work experience and requires moderate supervision, but can work independently on simple tasks. The intermediate proficiency level indicates that an Individual has had experience working independently on moderate complex assignments and the ability to support and guide others. The advanced proficiency level indicates that an individual has had significant experience working and leading moderate to complex assignments, and capable of managing a team and responsible for the results of the team. The expert proficiency level indicates that an individual is regarded as the expert in the competency, and the individual develops, implements and advocates the processes and standards in the field.

Referring briefly to FIG. 21 that illustrates a competency dictionary 122 arranged into group competency definitions 2100. The group competency definitions 2100 may comprise competency domains 2102 that correspond to the competency model domains (e.g., 602, 604, 606, and 608). The competency domains 2102 comprise group competencies 2104 that correspond to the model functional competencies (e.g., 610, 612, 614, and 616). Each group competency 2104 comprises a group competency definition 2106.

The technology and infrastructure competency domain encompasses all competencies required for an individual to perform and deliver results efficiently and effectively. The business competency domain encompasses all competencies required for an individual to understand how the organization is run, the direction the organization is headed, plan work, maintain relationships both external and internal, and align the workforce to achieve organizational goals. The Process/Methodology competency domain encompasses all competencies required for an individual to understand the process and guidelines that the organization has developed to help individuals deliver results that are in line with the organization's strategy. The professional competency domain encompasses all the softer competencies that an individual may need to perform and deliver results efficiently and effectively. In one implementation, the group competencies 2104 may be measured qualitatively.

Tables 3 and 4 are exemplary only and illustrate detailed descriptions of the functional competencies and proficiencies of the application functional competency, as shown FIG. 21.

TABLE 3
Application Functional Competency

Description - Definition
Possesses knowledge and understanding of specific firm-wide applications.
Example Applications: Authoria, DB2/SQL, ERP (Enterprise Resource Planning),
Lotus/Outlook, Microsoft Project Server, Microsoft SQL, Microsoft Windows 200X
Server, Novell, Oracle, OS/2, OS/400, PeopleSoft, PHP, Rational Tool Suite,
RDBMS (Oracle 9.x, MSDE SQL Server 2000), SAP, Siebel, UNIX, Web Services, Windows
Sharepoint Services
Key Behaviors
Demonstrates understanding of different technology platforms
Evaluates and provides technical solutions to moderate application development
problems.
Measures accessibility and functionality of applications against benchmarks to
ensure business domain needs are being met
Masters techniques for designing, installing and/or maintaining applications
Defines design, installation and maintenance plans and approaches
Monitors application and makes recommendations for improvements to increase
the efficiency and reliability of the application
Skills
Recognize Industry Processes & Standards
Research & Develop
Roadmap Development
Strategic Planning
Architecture Storyboarding
Installation

TABLE 4
Application Functional Competency - Proficiencies

| | |
|---|---|
| Proficiency | Knows basic terminology and functionality of application |
| Level 1 | Knows basic structure of application |
| | Identifies purpose of application within firm |
| | Displays understanding of policies, processes and procedures related |
| | to application |
| Proficiency | Applies application policies, processes and procedures |
| Level 2 | Configure basic functionality |
| | Monitor and assess application performance level |
| Proficiency | Evaluates and provides technical solutions to moderate application |
| Level 3 | development problems. |
| | Measures accessibility and functionality of applications against |
| | benchmarks to ensure business domain needs are being met |
| | Implements repairs/upgrades to applications as they are developed |
| | Maintains test environments for system applications |
| Proficiency | Evaluates and provides technical solutions to complex application |
| Level 4 | development problems. |
| | Designs new processes and procedures |
| | Provides benchmarks for ensuring that applications are meeting the |
| | needs of the business domain which they serve. |
| | Oversee repair/upgrade application implementations |
| Proficiency | Maintains deep understanding of application |
| Level 5 | Review and validates new application solutions |
| | Align application functionality with business requirements and strategy |
| | Anticipates issues and challenges affecting application functionality |
| | Procures and implements additions to application portfolio while maintaining |
| | fiscal responsibility |

FIG. 9 illustrates a skills inventory 900. The skills inventory breaks down the functional competencies (e.g., 610, 612, 614, and 616) of the competency model 120 into sets of skills 902 recommended for each functional competency. In one implementation, the skills competency system 102 analyzes the skills 902 to map the competency model 120 to the current jobs (e.g., 136 and 138) of an organization, and maps courses and available content (e.g., 154, 156 and 108) in order to generate curriculum.

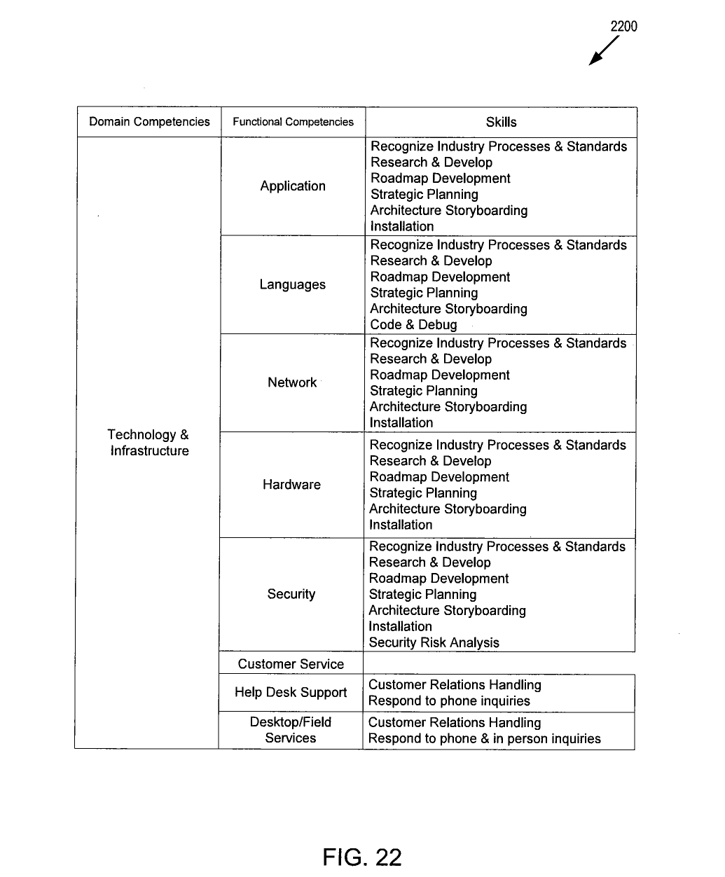

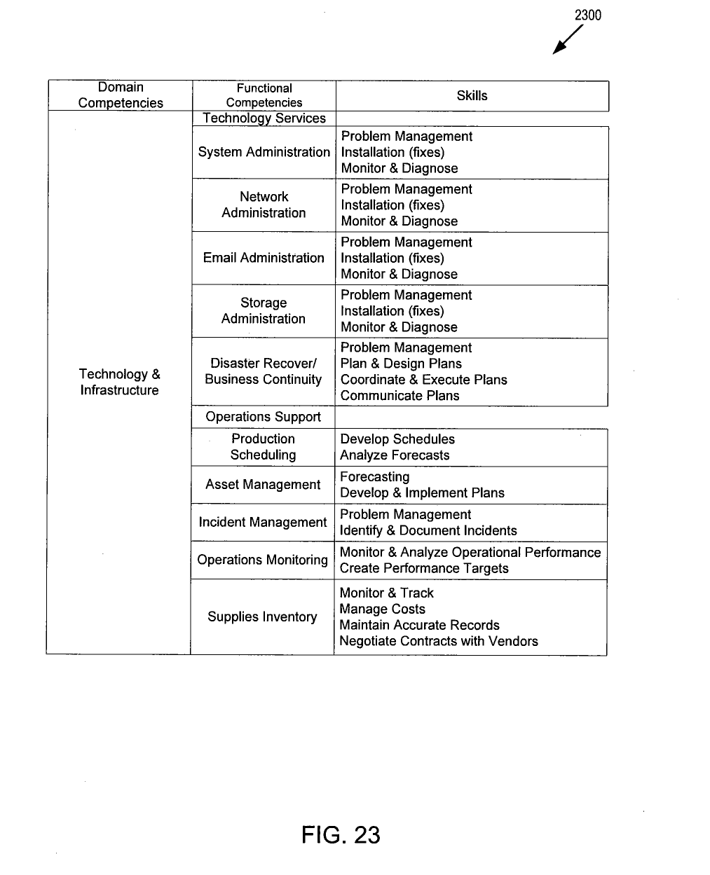

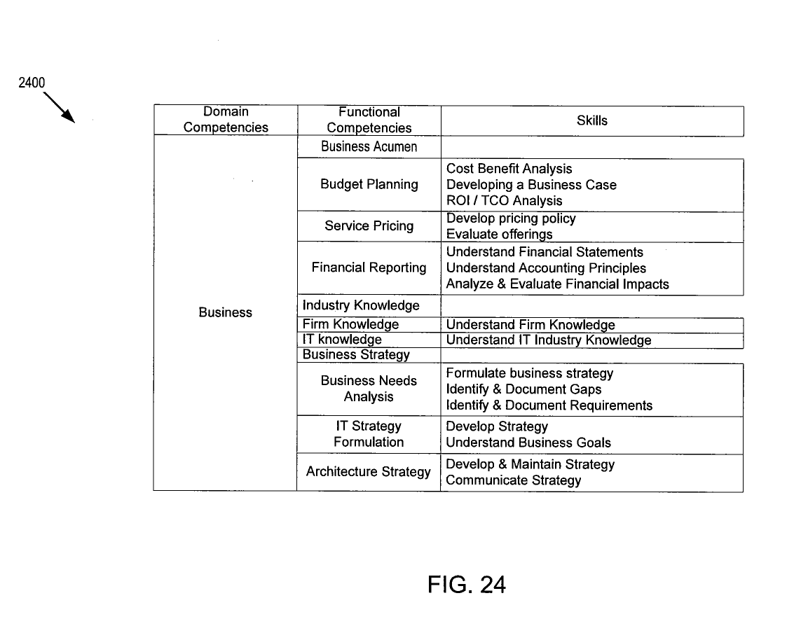

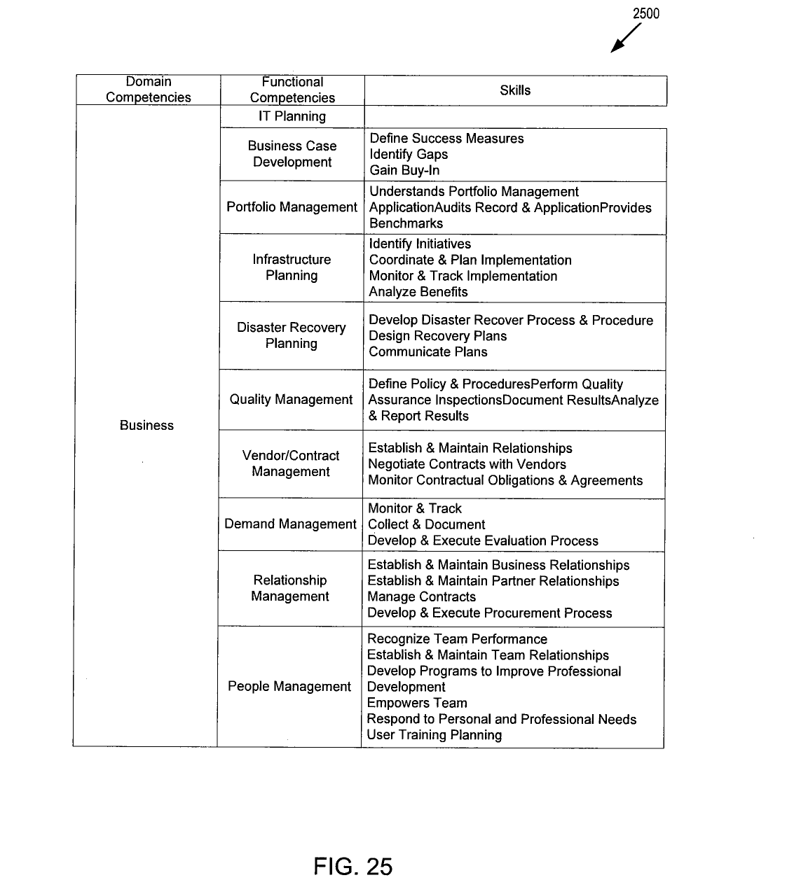

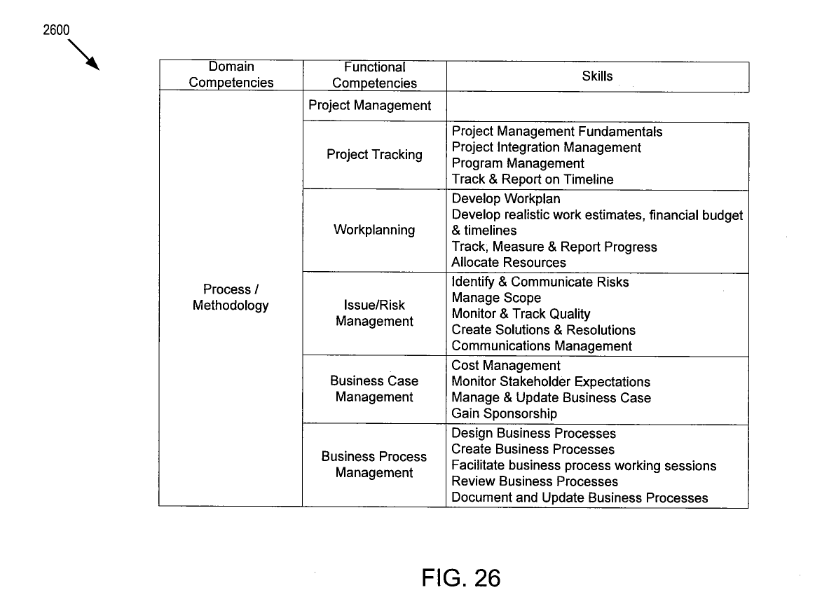

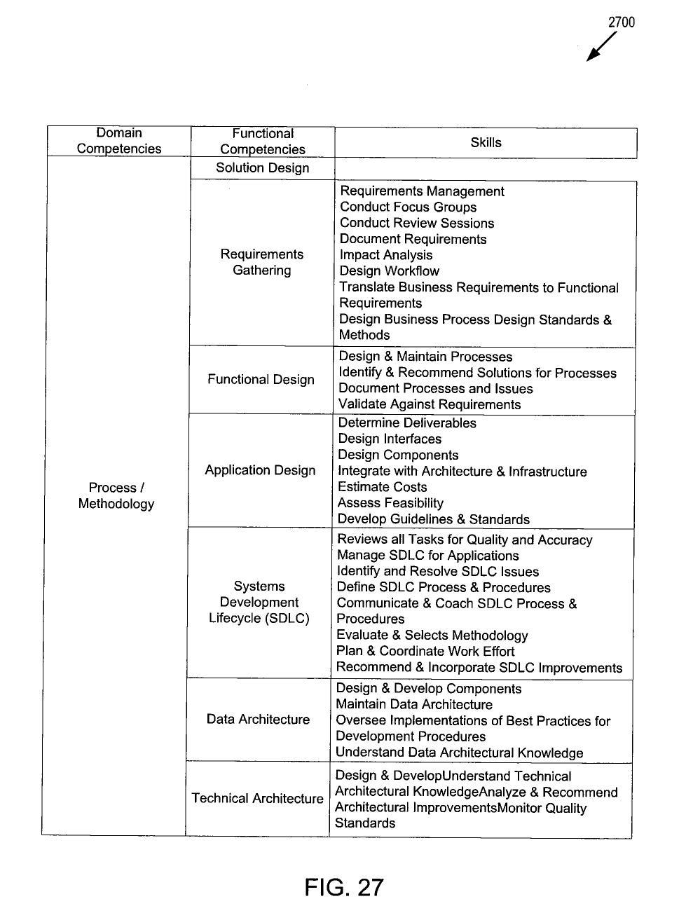

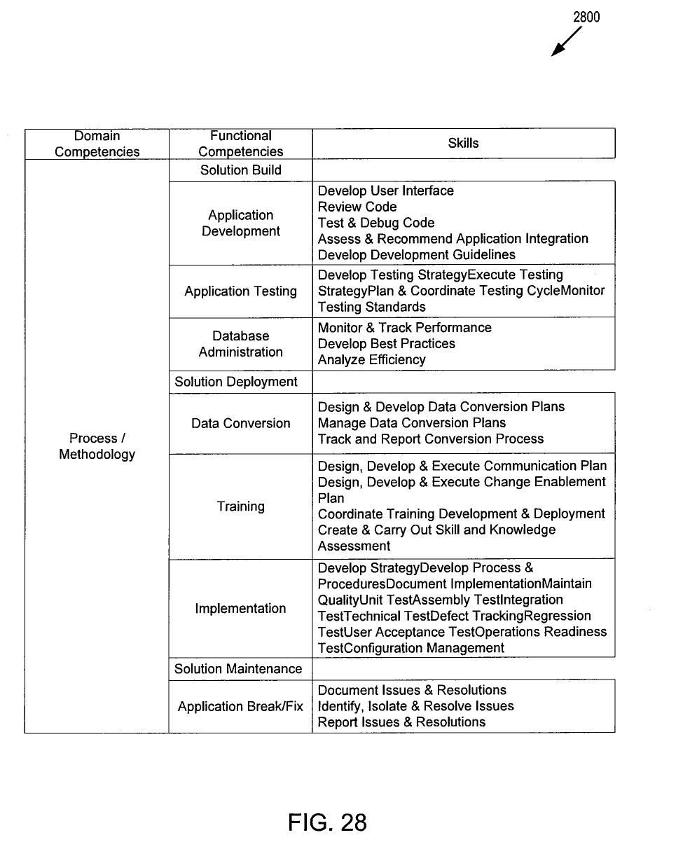

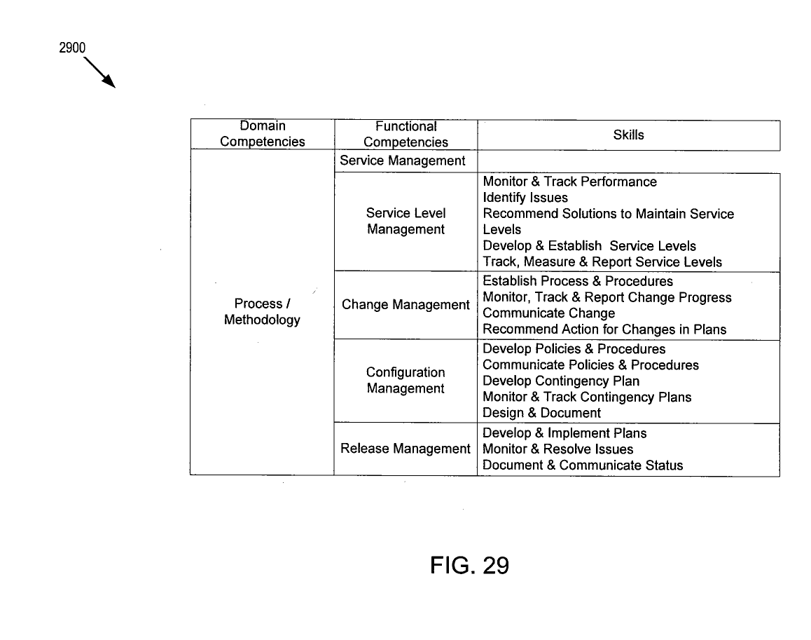

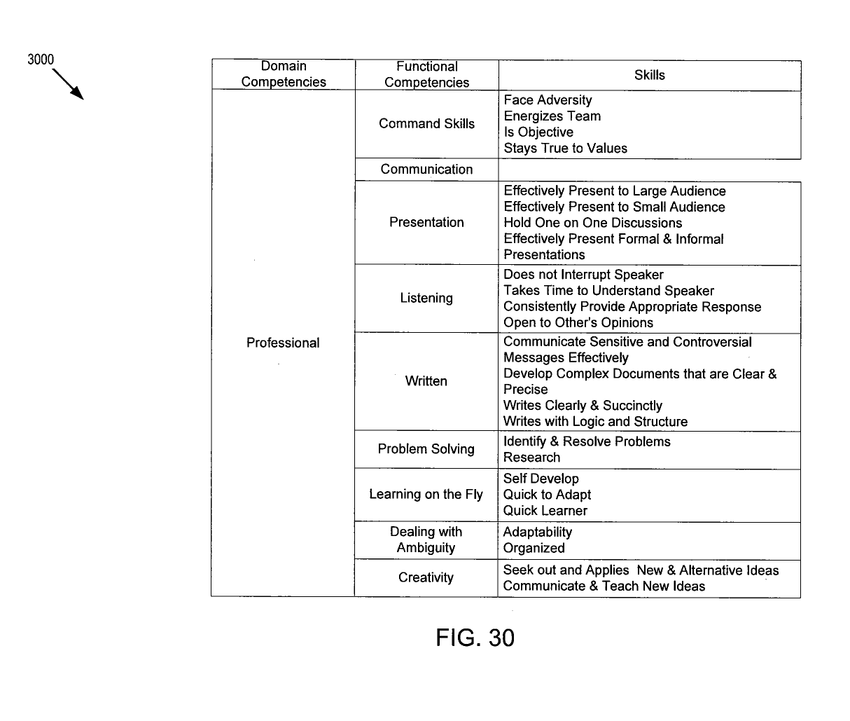

Referring briefly to FIG. 22 through FIG. 30, these figures illustrate in further detail skills arranged according to the functional competencies (e.g., 610, 612, 614, and 616) of the competency model 120. FIG. 22 illustrates a mapping of skills 2200 to functional competencies within the technology and infrastructure competency domain. FIG. 23 illustrates a further mapping of skills 2300 to functional competencies within the technology and infrastructure competency domain. FIG. 24 illustrates another mapping of skills 2400 to functional competencies within the business competency domain. FIG. 25 illustrates a further mapping of skills 2500 to functional competencies within the business competency domain. FIG. 26 illustrates another mapping of skills 2600 to functional competencies within the process and methodology competency domain. FIG. 27 illustrates a further mapping of skills 2700 to functional competencies within the process and methodology competency domain. FIG. 28 illustrates a further mapping of skills 2800 to functional competencies within the process and methodology competency domain. FIG. 29 illustrates a further mapping of skills 2900 to functional competencies within the process and methodology competency domain. FIG. 30 illustrates a mapping of skills 3000 to functional competencies within the professional competency domain.

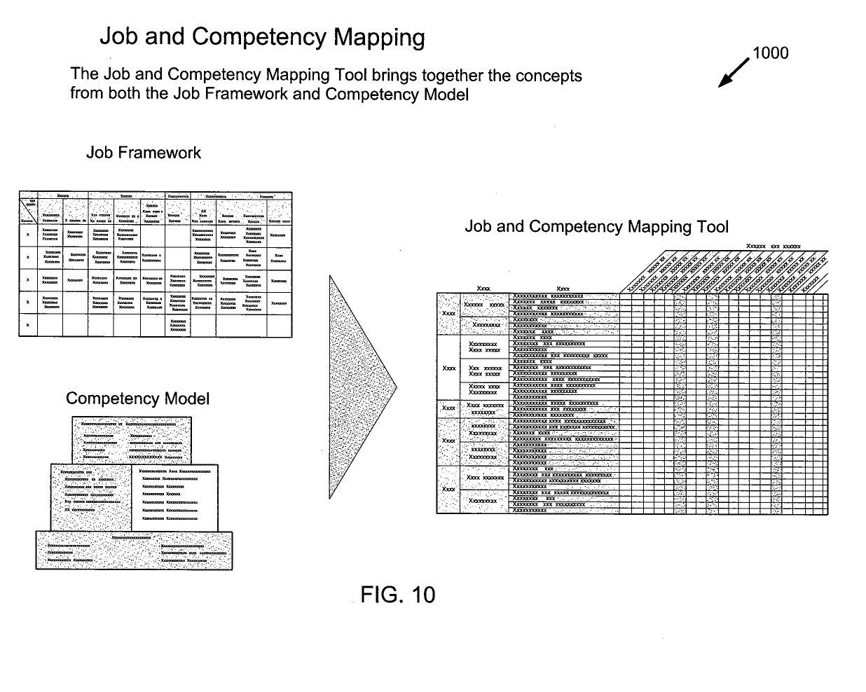

FIG. 10 illustrates an example of a job and competency mapping 1000 of the job framework (e.g., 132 and 142) and competency model 120. In one implementation, the job and competency mapping logic 126 generates the job and competency mapping 1000 by analyzing the jobs in each job family within the job framework (e.g., 132 and 142) and the functional competencies (e.g., 610, 612, 614, and 616) of each competency domain (e.g., 602, 604, 606, and 608) within the competency model 120. The job and competency mapping 1000 specifies the functional competency proficiency level (e.g., 824, 826, 828, 830 and 832) recommended for a person to appropriately perform a particular job within the job framework (e.g., 132 and 142). For example, the job and competency mapping 1000 specifies that an application functional competency proficiency level of 5 is recommended for the principal application engineer 543 job of the application engineering 506 job family. Tables 89 and 90 illustrate detailed descriptions for the application functional competency and corresponding proficiencies.

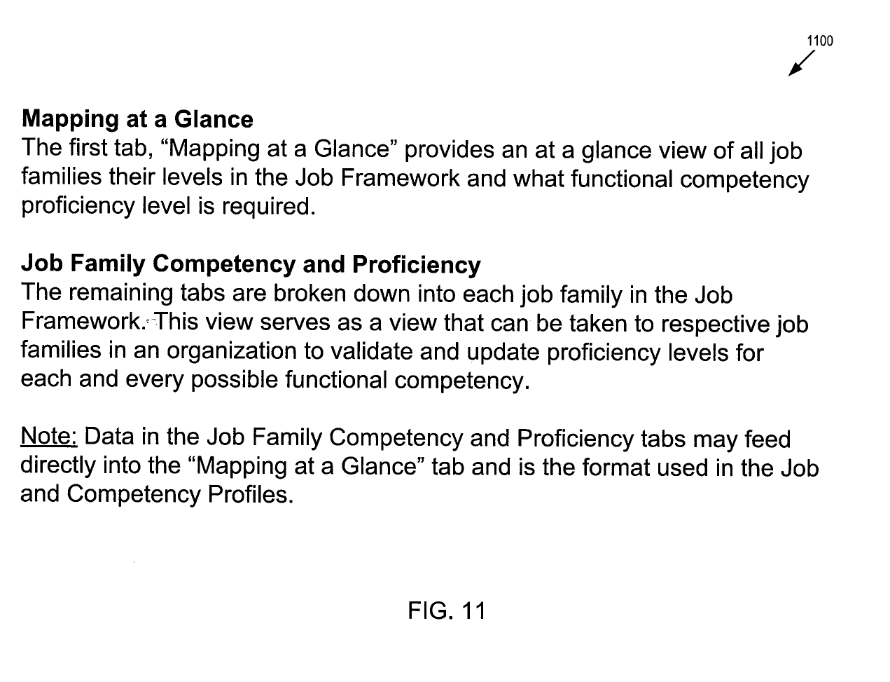

FIG. 11 illustrates a description of a mapping of job family competencies and proficiencies 1100. The description 1100 describes a mapping at a glance of all job families (e.g., 502, 504, 506, 508, 510, 512, 514, 516, 518, 520, and 522), family jobs, and job levels 534 in a job framework (e.g., 132 and 142).

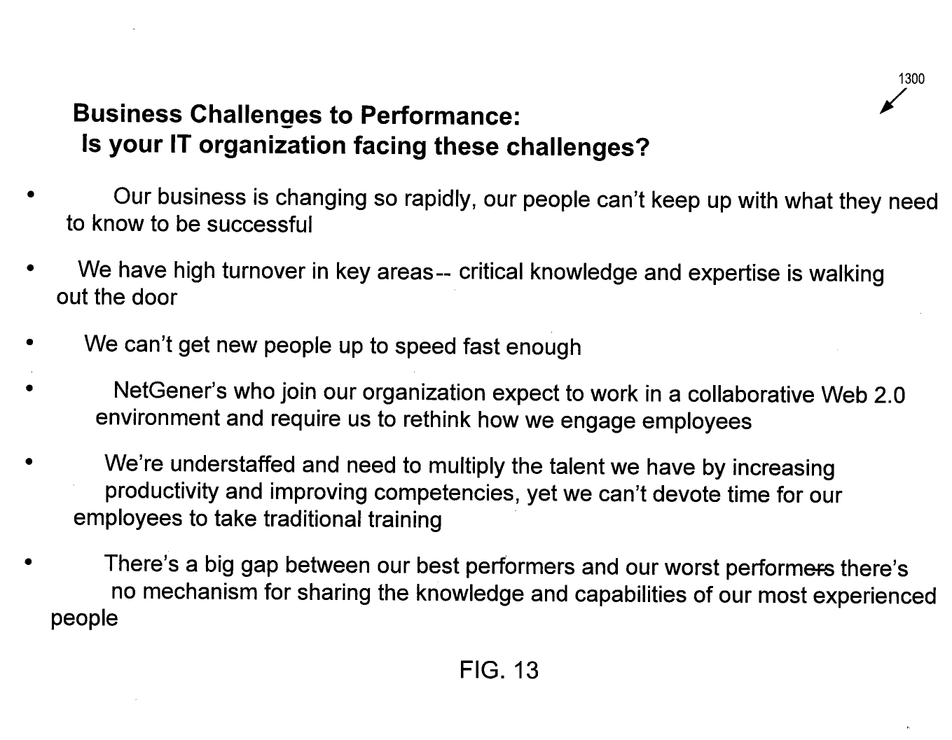

FIG. 13 illustrates business challenges 1300 to operational performance addressed by the skills competency system 102. In one implementation, the business challenges 1300 include: keeping workers of relevant information in a rapidly changing business and/or industry; high workers turnover in key areas and knowledge and expertise retention; training workers quickly; worker generational issues; understaffed workforce managed to increase productivity and improve competencies; and performance gaps between best worker performers and worst performers.

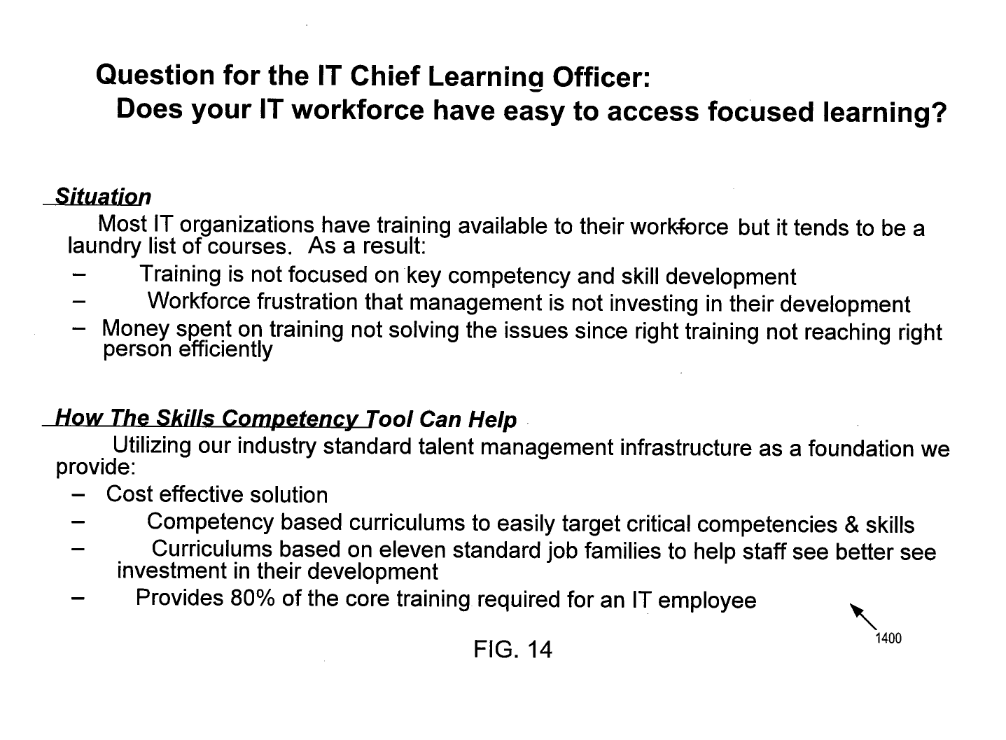

FIG. 14 illustrates chief learning officer issues 1400 addressed by the skills competency system 102. In one implementation, the chief learning officer issues 1400 include: identifying focused training directed to key competency and skill development; workforce's perception inadequate management investment in development training for the workforce; and efficiently identifying the right training for the right personnel.

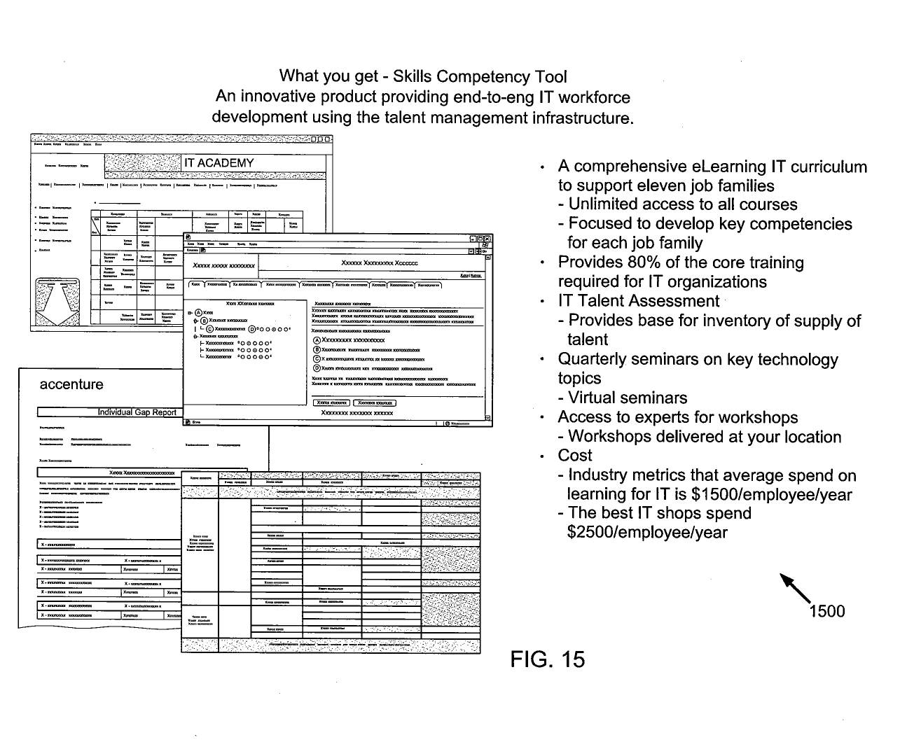

FIG. 15 illustrates potential outcomes 1500 that may result from implementing the skills competency system 102 for an organization. In one implementation, the potential outcomes 1500 include: a comprehensive eLearning IT curriculum; identifying the majority of the recommended core training for an IT organization; IT talent assessments; seminars on key technology topics; access to experts for workshops; competitive cost to benefit measures.

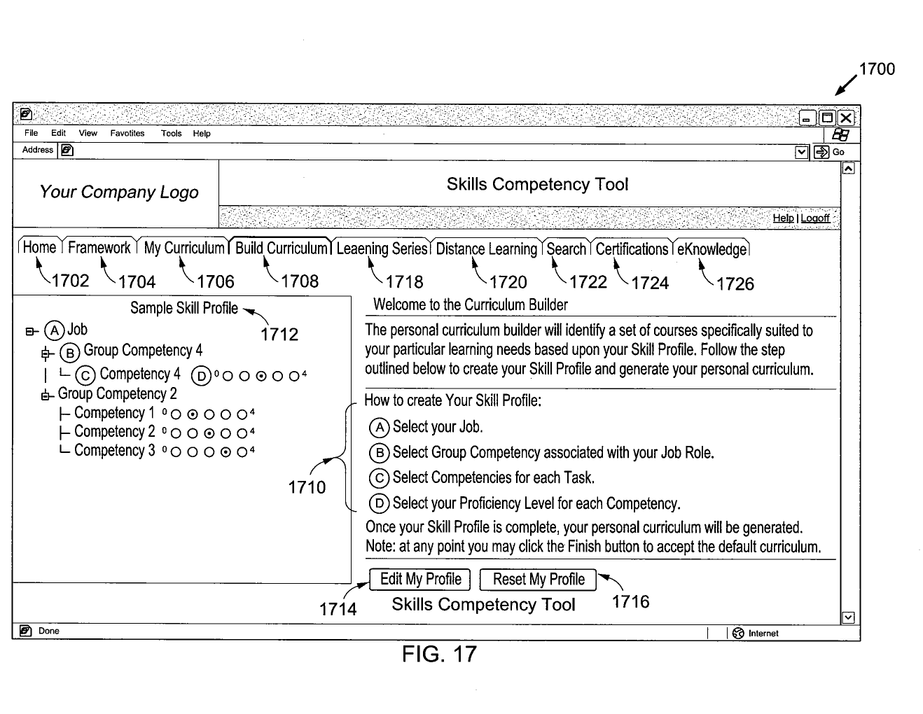

FIG. 17 illustrates a user interface 1700 for the skills competency system 102. In one implementation, the user interface 1700 (e.g., 106) presents a user 152 (e.g., employee, contractor, and/or skills competency administrator) with user selectable tabs that allow the user 152 to interact with various aspects of the skills competency system 102, including: home 1702; framework 1704; ‘my curriculum’ 1706; and build curriculum 1708. In one implementation, the home 1702 tab presents the user 152 with the home page of the user interface 1700 where the user may log into the skills competency system 102 and view general information regarding skills competency system 102. The framework 1704 tab displays one or more job frameworks (e.g., 132 and 142) to the user 152 so that the user may explore various job families (e.g., 502, 504, 506, 508, 510, 512, 514, 516, 518, 520, and 522) and family jobs (e.g., 535 through 575). The ‘my curriculum’ 1706 tab displays the curriculum established for the user 152 (e.g., employee and/or contractor).

In one implementation, a base curriculum may be prebuilt for the user 152 by the skills competency administrator using the build curriculum 1708 tab, and subsequently, customized by the user 152 using the user interface 1700. The user 152 may select the build curriculum 1708 tab, and following the instructions 1710, create a skills profile 1712 that the job and competency mapping logic 126 uses to build the curriculum for the user 152. The user 152 may edit the skills profile 1714 and reset the skills profile 1716. The job and competency mapping logic 126 generates the current job and competency training gap 162 for the user 152.

The user selectable tabs displayed to the user 152 in the user interface 1700 may further include: learning series 1718; distance learning 1720; search 1722; certifications 1724; and eknowledge 1726. In one implementation, the learning series 1718 tab displays defined learning curriculum for model jobs (e.g., 146 and 148) so that a user 152 may independently train for any particular job of interest. In one implementation, the distance learning 1720 tab displays available sources of carouse content 108 and course source locations 154. The distance learning 1720 tab may display communication portables to on-line workshops and training sessions. In one implementation, the search 1722 tab present the user 152 with a query field to search for course source locations 154, course content 156, and sources of course content 108, and any other searchable information necessary to implement, manage and maintain the skills competency system 102, and build and manage a user's curriculum. In one implementation, the certifications 1724 tab displays particular curriculum established to achieve certain certifications and general information regarding certifications relevant to the job frameworks (e.g., 132 and 142). In one implementation, the eknowledge 1726 tab displays a knowledge management portal useable to retain knowledge specific to the organization (e.g., internal training material and post-project debriefing reports to capture knowledge).

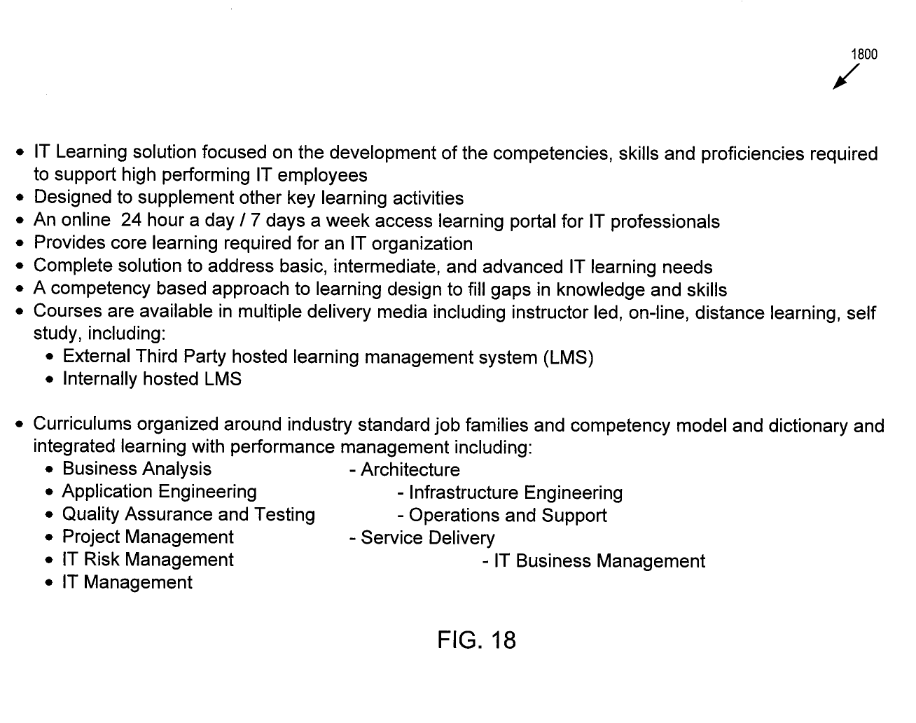

FIG. 18 illustrates benefits 1800 of implementing the skills competency system 102. The benefits 1800 include a learning solution focused on the development of the competencies, skills and proficiencies to support a high performing IT workforce. The benefits 1800 also include providing the workforce with a multimedia delivery solution that includes instructor lead, on-line, self-paced, and distance learning capabilities.

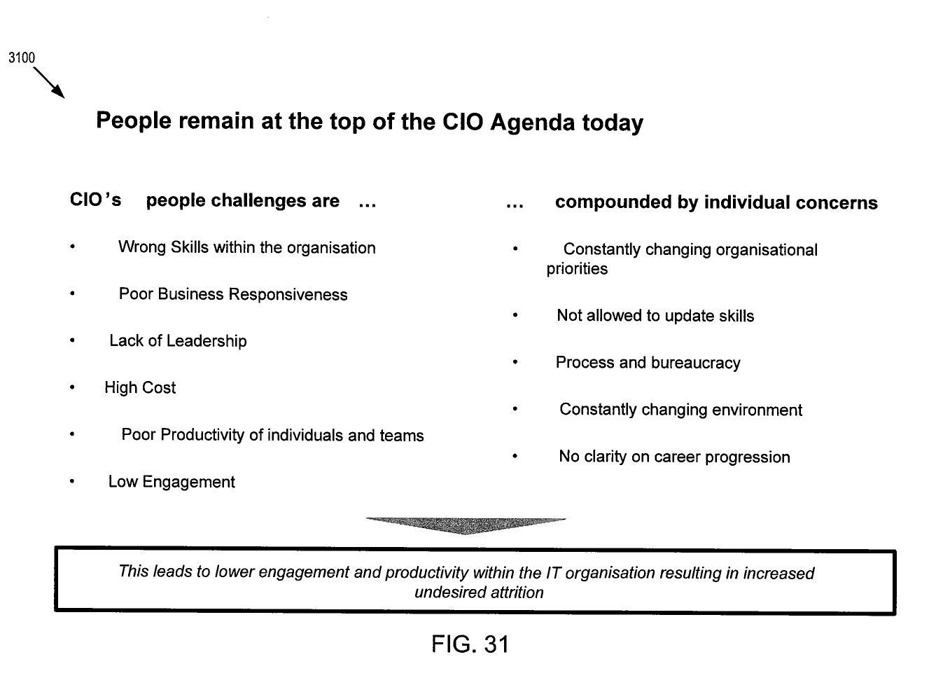

FIG. 31 illustrates chief information officer (CIO) workforce related considerations 3100. In one implementation, the CIO workforce considerations 3100 include: identifying and supporting development of the appropriate skills for the workforce; improving business responsiveness with a better trained workforce; increase leadership effectiveness; and lower operating costs by improving workforce productivity. In one implementation, the CIO workforce considerations 3100 also include: providing a training solution that addresses rapidly changing organizational priorities and industry changes; facilitating workforce training and skills development; minimizing bureaucracy and process related to training the workforce; and assisting the workforce to realize clear career options and progressions.

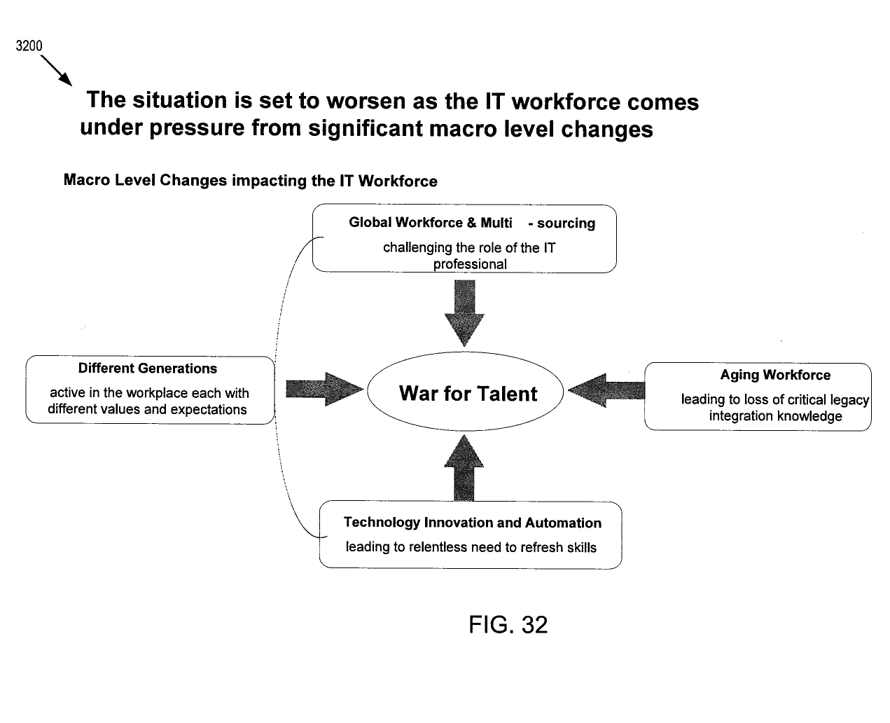

FIG. 32 illustrates factors 3200 related to identifying, acquiring and maintaining qualified workforce talent. In one implementation, the factors 3200 include: a global workforce and multi-sourcing; an aging workforce; rapid technology innovation and automation; and workforce cultural and generational differences.

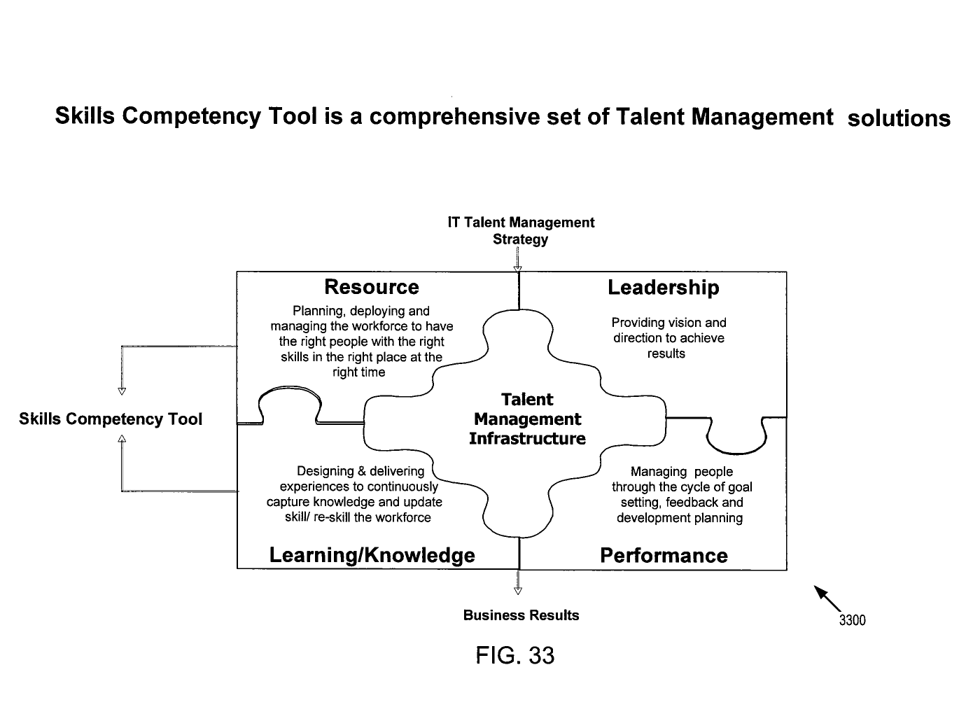

FIG. 33 illustrates benefits 3300 provided by the skills competency system. In one implementation, an organization may deploy the skills competency system 102 to implement a talent management infrastructure that supports execution of the organization's talent management strategy to achieve targeted business results. In one implementation, the benefits 3300 include: improved leadership; effective and efficient utilization of resources; continuous knowledge capture and skills updating by the workforce; and enhanced workforce performance and productivity.

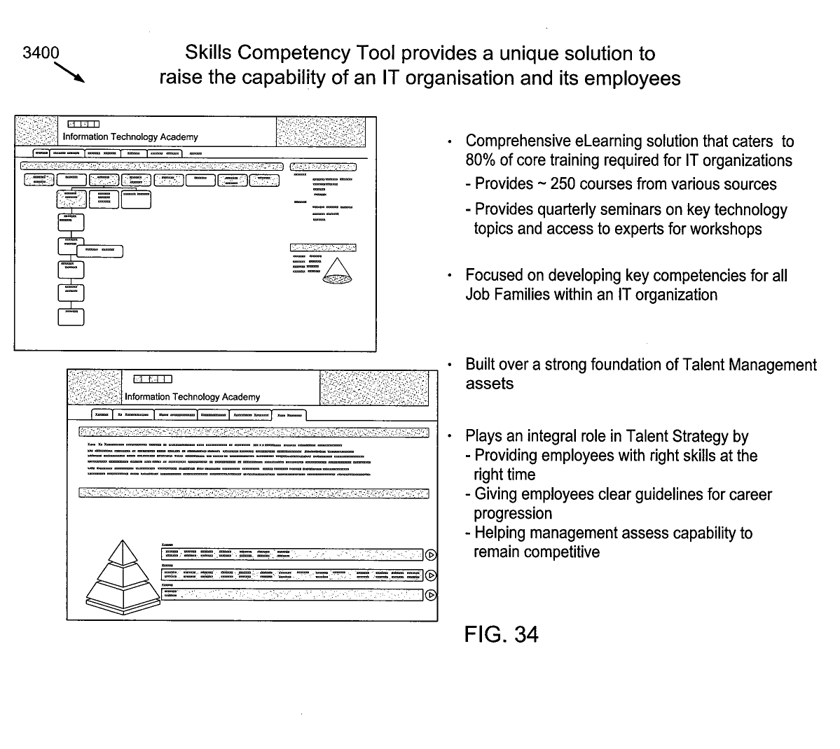

FIG. 34 illustrates exemplary skills competency benefits 3400 that may result from implementing the skills competency system. In one implementation, the skills competency benefits 3400 include a comprehensive eLearning solution that addresses the majority of core training for an IT organization, courses from various sources, seminars on key technology topics, and access to experts for workshops. The skills competency benefits 3400 may focus on developing key competencies for all job families within an organization, provide the workforce with clear guidelines for career progression, and facilitate management to assess capabilities in order for the organization to become and/or remain competitive.

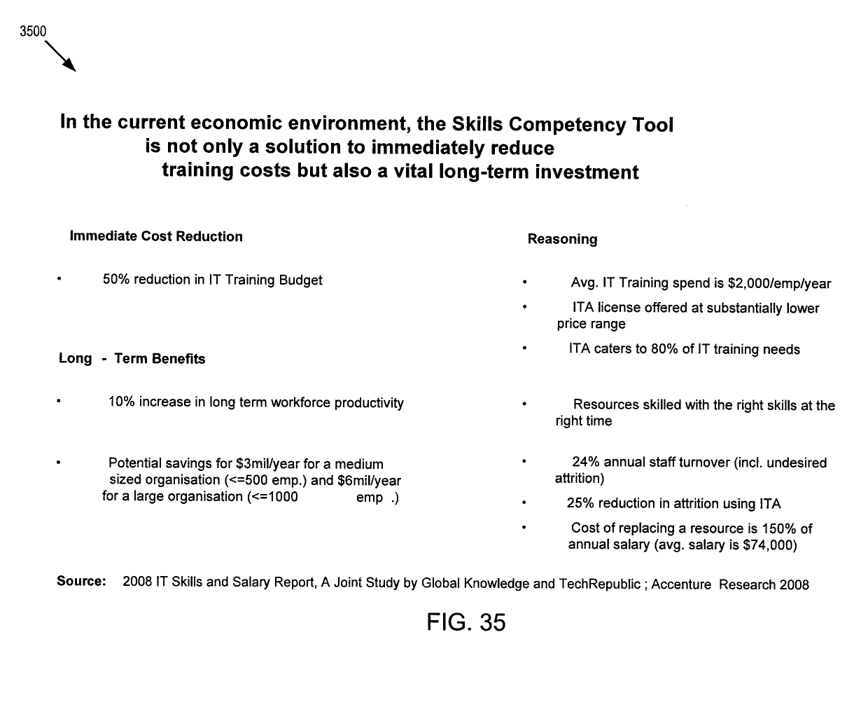

FIG. 35 illustrates exemplary skills competency long-term benefits 3500 that may result from using the skills competency system. In one implementation, the skills competency long-term benefits 3500 include reducing training costs, increase long-term workforce productivity.

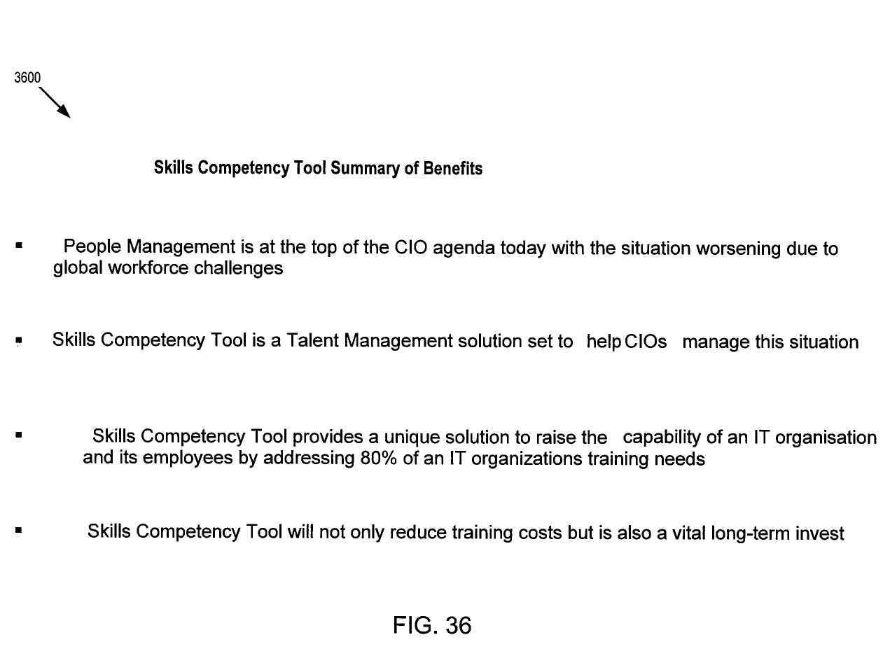

FIG. 36 illustrates a summary of benefits 3600 that may result from using the skills competency system. In one implementation, the summary of benefits 3600 include providing a talent management solution to address people management issues for chief information officers, and raising the capabilities of the organization and workforce by addressing the majority of training needs.

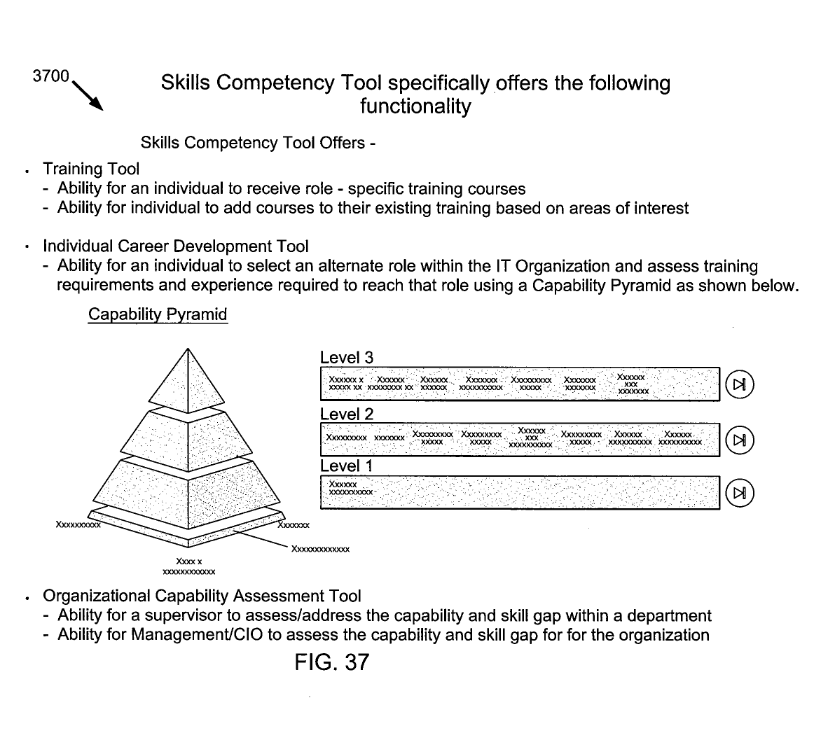

FIG. 37 illustrates exemplary skills competency functionality 3700 available to a user of the skills competency system. In one implementation, the skills competency functionality 3700 includes a training tool, individual career development tool and organizational capability assessment tool. The skills competency functionality 3700 as a training tool includes the availability of role specific training course, the ability to customize a personal training plan to include courses of personal interest. The skills competency functionality 3700 as an individual career development tool includes the ability to select an alternate role within the organization and assess training requirements and experience required to reach that role using a capability pyramid (e.g., competency model 120). The skills competency functionality 3700 as an organizational capability assessment tool includes the ability for supervisors to assess and address capability and skill gaps of the workforce, and the ability for management to assess the capability and skill gap for the organization overall.

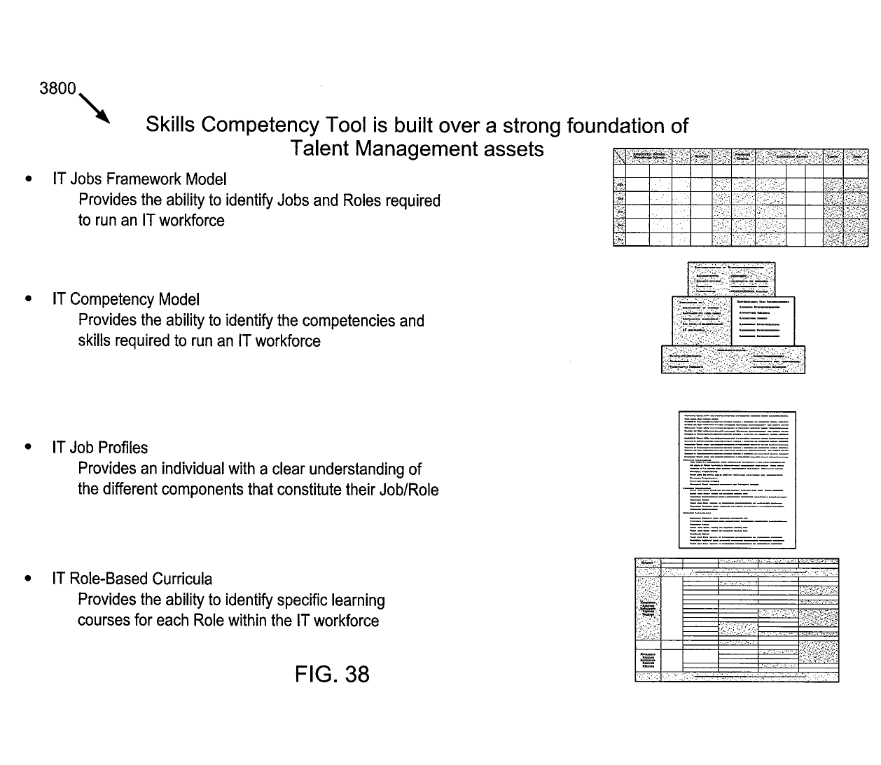

FIG. 38 exemplary illustrates talent management assets 3800 provided by the systems management system. In one implementation, the talent management assets 3800 include a IT job framework model, IT competency model, IT job profiles and IT role-based curricula. The IT job framework model may provide an organization with the ability to identify jobs and roles required to run an IT workforce. The IT competency model may provide the organization with the ability to identify the competencies and skills required to run an IT workforce. The IT job profiles may provide an individual with a clear understanding of the different components that constitute the individual's job and/or role within the workforce. The IT role-based curricula may provide the organization and workforce to identify specific learning course for each role within the IT workforce.

An organization may undertake to create a process to develop “Subject Matter Experts” across the information technology (IT) workforce of the organization in order to increase the internal knowledge transfer and bench strength of the organization. The overall objective of the organization may include attracting, developing and retaining a highly skilled information technology workforce capable of supporting the delivery of the organizations strategic and operational initiatives. The skills competency system assists the organization in the development of a core-program that builds subject matter expertise at the local (e.g., departmental) level by using two approaches: developing a long-term learning-focused program (SME Curriculum); and a short-term task based program Knowledge Transfer Toolkit. The application of the skills competency system produces: Subject Matter Expert Identification Matrix; SME Learning Curriculum (Core—Advanced); Learning and Knowledge Transfer Toolkit; Content Management Process (and maintenance schedule for learning content); Communication and Stakeholder Management Program Plan; and recommendations for redesigning the organization's approach to learning. An organization may use the skills competency system to initiate and provide: an organization's Subject Matter Expert and Knowledge Owner development program; design concepts for interactive deliverables (SME Implementation Toolkit and Knowledge Transfer Plan); a skill and curriculum gap analysis to identify hot skills for alignment with course development needs; create course development proposals, roadmap and course delivery schedules for design and delivery phases of work; and delivery of a Basic Course curriculum.

In another example, an organization may use the skills competency system to reorganize the organization and provide a talent management assessment of the IT organization. The skills competency system may be used to ensure that the current market-sourced strategy for key IT roles align with industry-best practices. The organization may desire to define a performance and employee development program that allows for vertical and/or horizontal movement within the IT organization in order to retain exemplary employees. In an effort to understand the mix of skills, competencies, on/offshore workforce demographics, the skills competency system may be used to create an IT Workforce Transformation Roadmap and arsenal of Talent Management solutions. The skills competency system includes a functional competency model for IT, a tiered Job Framework, Customized Competency Dictionary, a competency proficiency scale (Trained—Expert), detailed job descriptions with complete set of competencies mapped to target proficiency targets, Behavioral Interview Guides by Job Family, Change/Stakeholder Management Recommendations, and Job-Family Learning Enablers (and Curricula). The skills competency system may allow an organization to design and craft an IT Workforce Transformation Roadmap, garner overwhelming support and acceptance at the Senior Leadership Team Level, assess the selection and review of learning solutions and skill assessment tools, and an organization's internal learning organization (e.g., training department) for mapping and incorporation of learning solutions and skill assessment tools.

The skills competency system may be used to establish a talent management “infrastructure” to better manage the IT workforce of today, and prepare for changes in the workforce of the future. To that end, the skills competency system may be used to simplify the current job structure and enable consistency across the organization on how positions and roles are defined. The organization may use the skills competency system to develop methods and procedures to increase employee engagement, improve overall satisfaction and retention. The skills competency system may be used to implement a new job framework and competency model in an IT organization. The skills competency system may be used to establish a customized job framework that defines specific responsibilities and competencies to define an employee's potential career path. The skills competency system provides IT employees direct visibility to vast potential opportunities for career development and professional growth, while improving an IT organization's ability to effectively and efficiently staff IT projects, and increase employee retention. The skills competency system may be used to build the career framework for the IT organization, Identify new position families, Map current employees to job families, Catalog job skills according to the new competency model, and provide an implementation roadmap that includes knowledge transfer. The skills competency system provides: job titles that are mapped to new job titles in job families; IT employees can identify their jobs mapped to the new job framework; a consistent set of competencies; mapped to the new job titles; provided the IT department with a framework for creating development plans; and effectively staff projects with the most qualified individuals; Create a detailed implementation plan for the new career model; and facilitates the development of tools to support the IT Organization as a high performing technology organization.

The skills competency system may assist an organization to manage the IT workforce in order to play a critical role in several new business strategies. The organization's current workforce may not support the targeted new business strategies, so the organization may use the skills competency system to plan and build a workforce to achieve the new business strategies. To that end, the skills competency system may be used to establish a workforce-wide method for describing roles, responsibilities, competencies and proficiency levels. The skills competency system establishes a common terminology that the organization may use to describe the workforce in a way that the entire organization can understand. The skills competency system provides the organization a way of assessing and/or inventorying the skill sets of the organization's workforce. The skills competency system may be used by the organization and/or the organization's training department (e.g., Information Technology ‘IT’ learning group) to perform an assessment of the effectiveness of the organization's training curriculum. The organization may use the skills competency system to assess the organization's current curriculum, and determine whether an appropriate competency framework exists that can measure the effectiveness of the organization's training initiatives. The competency model may be used to map competencies to the jobs of the organization, create a common language across the organization, and assess the organization's current job competencies against targeted job competencies.

The system may be implemented in many different ways. For example, although some features are shown stored in computer-readable memories (e.g., as logic implemented as computer-executable instructions or as data structures in memory), all or part of the system, logic, and data structures may be stored on, distributed across, or read from other machine-readable media. The media may include hard disks, floppy disks, and CD-ROMs. The logic may be encoded in a signal, such as a signal received from a network or partitioned into sections and received in multiple packets communicated across a network. The system may be implemented in software, hardware, or a combination of software and hardware. The system may also use different message formats, in addition to XML, such as encoded packets with bit fields that are assigned specific meanings.

Furthermore, the system may be implemented with additional, different, or fewer components. As one example, a processor or any other logic may be implemented with a microprocessor, a microcontroller, a DSP, an application specific integrated circuit (ASIC), program instructions, discrete analog or digital logic, or a combination of other types of circuits or logic. As another example, memories may be DRAM, SRAM, Flash or any other type of memory. The system may be distributed among multiple components, such as among multiple processors and memories, optionally including multiple distributed processing systems. Logic, such as programs or circuitry, may be combined or split among multiple programs, distributed across several memories and processors, and may be implemented in or as a function library, such as a dynamic link library (DLL) or other shared library.

A number of implementations have been described. Nevertheless, it will be understood that various modifications may be made without departing from the spirit and scope of the invention. Accordingly, other implementations are within the scope of the following claims.

What is claimed is:

1. A skills competency system comprising:
a processor;
a memory coupled to the processor, the memory comprising:
model jobs for an organization;
a model job and competency profile for each of the model jobs;
a competency model comprising model functional competencies;
model functional competency definitions and skills inventory functional competency definitions for each of the model functional competencies;
current job and competency profile elements for current jobs of the organization;
job and competency mapping logic comprising instructions, that when executed by the processor, cause the processor to:
locate sources of available courses relevant to the model jobs;
evaluate the available courses to determine that the available courses satisfy training requirements for the model job and competency profile elements;
execute a comparison of the current job and competency profiles elements to the model functional competency definitions and the skills inventory functional competency definitions;
responsive to the comparison, determine:
a current job to model job definition gap; and
a current job and competency training gap; and
create a training plan responsive to the current job to model job definition gap and the job and competency training gap, the training plan comprising a training schedule including at least one of the available courses.

2. The skills competency system of claim 1, where the model job and competency profile comprises model job and competency profile elements, selected from among:
a model job title;
a model job summary that summarizes purpose and responsibilities;
model job responsibilities;
forecasted model job career roles a person holding the model job may be assigned during the person's career;
model competencies and proficiency levels a person should possess for the model job.

3. The system of claim 1,
where the memory further comprises a job and competency mapping threshold;
where the model jobs comprise a first job; and
where the job and competency mapping logic further comprises instructions, that when executed by the processor, cause the processor to:
determine whether a first job and at least one of the model functional competency definitions and at least one of the skills inventory functional competency definitions match the job and competency mapping threshold; and
generate a first mapped job gap assessment comprising difference job and competency profile elements that do not match the first job and the at least one of the model functional competency definitions and the at least one of the skills inventory functional competency definitions.

4. The system of claim 1, where the job and competency mapping logic further comprises instructions, that when executed by the processor, cause the processor to:
identify competency and proficiency level deficiencies for current functional competencies of the current job based on current competencies and proficiency levels for a person assigned the current job; and
identify a personalized training curriculum for the person comprising selected courses from the available courses.

5. The system of claim 1, where the competency model further comprises competency domains that categorize the model functional competencies, the competency domains selected from among:
a professional competency domain;
a business competency domain;
a process and methodology competency domain; and
a technology and infrastructure competency domain.

6. The system of claim 1, where the memory further comprising:
a competency dictionary comprising the model functional competency definitions, the model functional competency definitions each comprising:
a model functional competency description;
model proficiency levels;
model proficiency level definitions that define the criteria for each model proficiency level, or any combination thereof; and
a skills inventory comprising the skills inventory functional competency definitions, the skills inventory functional competency definitions each comprising a model functional competency skill decomposition for a corresponding model functional competency among the model functional competencies.

7. The system of claim 4, further comprising workforce capability maturity tracker logic comprising instructions, that when executed by the processor, cause the processor to:
receive an updated job and competency training gap that confirms the available courses completed in the personalized training curriculum; and
generate a workforce capability maturity score for the person based on the available courses completed.

8. The system of claim 1, where the job and competency mapping logic further comprises instructions, that when executed by the processor, cause the processor to generate a workforce transformation roadmap comprising:
the job to model job definition gap;
the job and competency training gap;
a new jobs definition project plan comprising a schedule and a cost estimate to establish new job definitions based on the job to model job definition gap; and
a training project plan comprising a schedule and cost estimates for training employees based on the job and competency training gap.

9. The system of claim 1, where the memory further comprises a model job framework that defines the model jobs, the model job framework comprising:
job family types including any combination of:
plan type job families;
build type job families;
operate type job families;
control type job families; and
lead type job families, where the job family types comprise job families that define family jobs and family job levels for each family job.

10. A skills competency method comprising:
defining components of a skills competency tool, using a graphical user interface coupled to a computer-readable memory and processor to receive user inputs, comprising:
defining model jobs for an organization;
defining a model job and competency profile for each of the model jobs;
defining a competency model comprising model functional competencies;
defining model functional competency definitions and skills inventory functional competency definitions for each of the model functional competencies;
storing, in the computer-readable memory, the components of the skills competency tool;
receiving, in the computer-readable memory, current job and competency profile elements for current jobs of the organization;
receiving, in the computer-readable memory, locations of sources of available courses relevant to the model jobs;
evaluating, with instructions stored in the computer-readable memory and executed by the processor, the available courses to determine that the available courses satisfy training requirements for the model job and competency profile elements;
comparing, with the instructions stored in the computer-readable memory and executed by the processor, the current job and competency profiles elements to the model functional competency definitions and the skills inventory functional competency definitions to the comparison, determine:
a current job to model job definition gap; and
a current job and competency training gap; and
creating, with the instructions stored in the computer-readable memory and executed by the processor, a training plan responsive to the current job to model job definition gap and the job and competency training gap, the training plan comprising a training schedule including at least one of the available courses.

11. The skills competency method of claim 10, where the model job and competency profile comprises model job and competency profile elements, selected from among:
a model job title;
a model job summary that summarizes purpose and responsibilities;
model job responsibilities;
forecasted model job career roles a person holding the model job may be assigned during the person's career;
model competencies and proficiency levels a person should possess for the model job.

12. The skills competency method of claim 10, further comprising:
defining, in the computer-readable memory, a job and competency mapping threshold;
where the model jobs comprise a first job; and
determining, with the instructions stored in the computer-readable memory and executed by the processor, whether a first job and at least one of the model functional competency definitions and at least one of the skills inventory functional competency definitions match the job and competency mapping threshold; and
generating, with the instructions stored in the computer-readable memory and executed by the processor, a first mapped job gap assessment comprising difference job and competency profile elements that do not match the first job and the at least one of the model functional competency definitions and the at least one of the skills inventory functional competency definitions.

13. The skills competency method of claim 10, further comprising:
identifying, with the instructions stored in the computer-readable memory and executed by the processor, competency and proficiency level deficiencies for current functional competencies of the current job based on current competencies and proficiency levels for a person assigned the current job; and
identifying, with the instructions stored in the computer-readable memory and executed by the processor, a personalized training curriculum for the person comprising selected courses from the available courses.

14. The skills competency method of claim 10, where the competency model further comprises competency domains that categorize the model functional competencies, the competency domains selected from among:
a professional competency domain;
a business competency domain;
a process and methodology competency domain; and
a technology and infrastructure competency domain.

15. The skills competency method of claim 10, where defining components of a skills competency tool, using the graphical user interface coupled to the computer-readable memory and processor to receive user inputs, further comprises:
defining a competency dictionary comprising the model functional competency definitions, the model functional competency definitions each comprising:
a model functional competency description;
model proficiency levels;
model proficiency level definitions that define the criteria for each model proficiency level, or any combination thereof; and
defining a skills inventory comprising the skills inventory functional competency definitions, the skills inventory functional competency definitions each comprising a model functional competency skill decomposition for a corresponding model functional competency among the model functional competencies.

16. The skills competency method of claim 13, further comprising:
receiving, in the computer-readable memory, an updated job and competency training gap that confirms the available courses completed in the personalized training curriculum; and
generating, with the instructions stored in the computer-readable memory and executed by the processor, a workforce capability maturity score for the person based on the available courses completed.

17. The skills competency method of claim 10, further comprising:
generating, with the instructions stored in the computer-readable memory and executed by the processor, a workforce transformation roadmap comprising:
the job to model job definition gap;
the job and competency training gap;
a new jobs definition project plan comprising a schedule and a cost estimate to establish new job definitions based on the job to model job definition gap; and
a training project plan comprising a schedule and cost estimates for training employees based on the job and competency training gap.

18. The skills competency method of claim 10, further comprising defining a model job framework that defines the models, the model job framework comprising:
job family types including any combination of:
plan type job families;
build type job families;
operate type job families;
control type job families; and
lead type job families, where the job family types comprise job families that define family jobs and family job levels for each family job.

19. A skills competency product comprising a computer-readable memory encoded with instructions, that when executed by a processor, cause a data processing system to:
define model jobs for an organization;
define a model job and competency profile for each of the model jobs;
define a competency model comprising model functional competencies; and
define model functional competency definitions and skills inventory functional competency definitions for each of the model functional competencies;
receive current job and competency profile elements for current jobs of the organization;
receive locations of sources of available courses relevant to the model jobs;
evaluate the available courses to determine that the available courses satisfy training requirements for the model job and competency profile elements;
compare the current job and competency profiles elements to the model functional competency definitions and the skills inventory functional competency definitions to the comparison, determine:
a current job to model job definition gap; and
a current job and competency training gap; and
create a training plan responsive to the current job to model job definition gap and the job and competency training gap, the training plan comprising a training schedule including at least one of the available courses.

20. The skills competency product of claim 19, where the instructions, that when executed by a processor, further cause the data processing system to:
define a job and competency mapping threshold;
where the model jobs comprise a first job; and
determine whether a first job and at least one of the model functional competency definitions and at least one of the skills inventory functional competency definitions match the job and competency mapping threshold; and
generate a first mapped job gap assessment comprising difference job and competency profile elements that do not match the first job and the at least one of the model functional competency definitions and the at least one of the skills inventory functional competency definitions.

21. The skills competency product of claim 19, where the instructions, that when executed by a processor, further cause the data processing system to:
Identify competency and proficiency level deficiencies for current functional competencies of the current job based on current competencies and proficiency levels for a person assigned the current job; and
identify a personalized training curriculum for the person comprising selected courses from the available courses.

22. The skills competency product of claim 21, where the instructions, that when executed by a processor, further cause the data processing system to:
receive an updated job and competency training gap that confirms the available courses completed in the personalized training curriculum; and
generate a workforce capability maturity score for the person based on the available courses completed.

23. The skills competency product of claim 19, where the instructions, that when executed by a processor, further cause the data processing system to:
generate a workforce transformation roadmap comprising:
the job to model job definition gap;
the job and competency training gap;
a new jobs definition project plan comprising a schedule and a cost estimate to establish new job definitions based on the job to model job definition gap; and
a training project plan comprising a schedule and cost estimates for training employees based on the job and competency training gap.
